(19) United States
(12) Patent Application Publication
(10) Pub. No.: US 2013/0012314 A1
(43) Pub. Date: Jan. 10, 2013

(54) GAME SYSTEM, GAME SYSTEM CONTROL METHOD, AND COMPUTER PROGRAM FOR GAME SYSTEM

(75) Inventor: Takayuki Ishikawa, Tokyo (JP)

(73) Assignee: KONAMI DIGITAL ENTERTAINMENT CO., LTD., Tokyo (JP)

(21) Appl. No.: 13/634,940

(22) PCT Filed: Mar. 15, 2011
(86) PCT No.: PCT/JP2011/056040

§ 371 Date: Sep. 14, 2012

(30) Foreign Application Priority Data
Mar. 15, 2010 (JP) 2010-058506

(51) Int. Cl. A63F 13/00

(52) U.S. Cl. 463/31

(57) ABSTRACT

Provided is a game system which causes a player to be aware of an operation position during operation. An operation performed by the player is evaluated according to a degree of concordance between timings and a degree of concordance between positions, and a result of evaluation thus made is reflected in proceedings of the game. Accordingly, the player is aware of not only matching timings of operating operation portions with operation timings but also matching positions for operating the operation portions with operation positions constituted from a plurality of regions. The difficulty level of the game is therefore increased. Consequently, interest of the player in the game may be prevented from being lost.

### TECHNICAL FIELD

The present invention relates to a game system in which inputs are made to an input portion according to an indication displayed in a display portion, a game system control method, and a computer program for a game system.

### BACKGROUND ART

Japanese Patent Application Publication No. 2007-111568 [Patent Document 1] discloses a game system where a timing with which a player should touch a screen and a position to be touched by the player are visually indicated according to reproduced music. In the game system in the Patent Document 1, a touch operation by the player is evaluated, based on the timing of the touch and the position of the touch.

### PRIOR ART DOCUMENT

### Patent Document

Patent Document 1: Japanese Patent Application Publication No. 2007-111568

### SUMMARY OF THE INVENTION

### Technical Problem

In the related art game system described in Patent Document 1, it is determined whether or not the player has touched a position within a region to be touched, with a specified input timing. When the player has touched the region to be touched, with the specified input timing, the touch is determined to be a “success”. When the player has touched a position outside the region to be touched, the touch is determined to be a “failure”. Consequently, when the player has reached a certain level or higher, he gets to touch the screen aimlessly, not caring about a position to be touched. He does not become conscious of improvement in his input operation skill. Accordingly, there is a problem that interest of the player in the game will gradually decrease.

In the game system in Patent Document 1, a touched region is evaluated based on two regions alone, that is, a region of the “success” and a region of the “failure”. Accordingly, no variation can be produced in an input (touch) result of the player. In other words, in the related art game system, even if the player has touched different positions in the region of the “success”, evaluation results he can obtain are the same. Further, since no variation can be produced in the input result, a desire of the player to obtain a better play result by playing better than other players cannot be satisfied.

An object of the present invention is to provide a game system, a game system control method, and game system program which cause a player to be aware of an operation position during operation.

Another object of the present invention is to provide a game system capable of increasing variation in a result of evaluation of an operation based on an operation position and an operation timing.

### Solution to Problem

The present invention aims at improvement of a game system comprising a display portion operable to display game images; one or more operation portions to be operated by a player; a storage portion; a timing detecting portion, an operated position detecting portion; and a game executing portion.

The storage portion stores game data at least including sequence data and image data. The sequence data is data defining timings to be used for game, including operation timings during the game. The image data includes at least data used to display in the display portion timing images and data used to display in the displayed portion operation position images. The timing images are images indicating to the player the operation timings for the one or more operation portions. The operation position images are images indicating to the player operation positions constituted from a plurality of regions to accept operations from the one or more operation portions with the operation timings. In this description, the term “operation position” not only indicates a point, but also includes a region extending to a certain extent. Further, in this description, the term “plurality of regions to accept operations” means a plurality of regions demanded to be operated.

The timing detecting portion detects timings with which the player has operated the one or more operation portions. In this description, the phrase “the player operates the operation portion” means not only operating an input portion directly by the player using a hand or a foot but also operating the operation portion by the player using an operation member such as a stick. The operated position detecting portion detects positions, as operated positions, at which the player has operated the operation portions. The operated position may readily be detected by a method of determining positions to which force is applied by using a plurality of force sensors provided for each operation portion or a method of using a touch panel as an operation portion.

The game executing portion executes the game with the game images being displayed in the display portion based on one or more operation signals output from the one or more operation portions and the game data.

The game executing portion of the present invention in particular displays the timing images and the one or more operation position images in the display portion according to the sequence data. The operation position images and the timing images are displayed as a portion of the game images. The operation timings and the operation positions constituted from the plurality of regions to accept the plurality of operations are appropriately set according to contents of the game. The operation timing may arbitrarily be indicated. A moment that the timing image has crossed a fixed target image may be set to the operation timing. Alternatively, a moment that the timing image has spread toward a screen frame and the contour of the timing image has crossed the screen frame may be pointed out as an example of the operation timing. The operation positions constituted from the plurality of regions may be indicated by an arbitrary method. All of the plurality of regions may be displayed by using images. In this case, the plurality of operation position images are displayed. Alternatively, a portion of the plurality of regions may be displayed by using one or more images. When only one of the plurality of regions in particular is displayed, one operation position image is displayed. In this case, the displayed one region is displayed as a so-called best region (best position).

The game executing portion of the present invention is further configured to evaluate the operation performed by the player based on degrees of concordance between the operation timing defined by the sequence data and the timing detected by the timing detecting portion and between each of the operation positions indicated by the one or more operation position images and the operated position detected by the operated position detecting portion and reflect a result of evaluation thus made in proceedings of the game.

By configuring the game executing portion as mentioned above, the result of evaluation obtained from evaluation of the operation by the player changes according to the position of the operation portion operated by the player as well as the timing with which the player has operated the operation portion. Accordingly, the player is caused to be aware of not only matching the timings of operating the operation portions with the operation timings but also matching the positions of operating the operation portions with the operation positions constituted from the plurality of regions. The difficulty level of the game is therefore increased. Consequently, interest of the player in the game may be prevented from being lost.

A separate value of evaluation may be given to each of the plurality of regions to accept the operations at the operation positions. In this case, the game executing portion evaluates the operation by the player, in view of values of evaluations given to the plurality of regions, for example. The separate value of evaluation to each of the plurality of regions may be given by configuring an evaluation value giving portion in the game executing portion, for example. Such arrangement makes the player aware that he or she would operate one of the plurality of regions having a higher value of evaluation from among the plurality of regions that accept the operations. The difficulty level of the game may be therefore further increased. The value of evaluation to be given to each of the plurality of regions may be, of course, appropriately determined according to the contents of the game to be executed by the game system.

Preferably, the game executing portion is configured to display the operation position images in the display portion such that the relationship between the plurality of regions and the values of evaluation may visually be confirmed. With this arrangement, the relationship between the plurality of regions and the values of evaluation may intuitively be grasped from the operation position images displayed in the display portion. The burden of the player for determination may be therefore reduced. Consequently, the player may concentrate on the game.

The operation position images to be displayed by the game executing portion may be displayed in an arbitrary form in order to allow visual confirmation of the relationship between the plurality of regions and the values of evaluation. The display colors of the operation position images may be changed according to the values of evaluation, for example. When such operation position images are used, it may be determined according to the display color of each operation position image whether the value of evaluation is high or low. The relationship between operations on the plurality of regions constituting the operation positions and the values of evaluation may intuitively be recognized. The burden of the player for determination may be therefore reduced. Consequently, the player may further concentrate on the game.

The game executing portion may use an arbitrary display method of displaying the timing images and the operation position images. The game executing portion may display the timing images and the operation position images using one common image, for example. Especially when the game executing portion integrally displays the timing images and the operation position images, the player may obtain information on the operation timings and the operated positions just by viewing one image. As a result, the player may readily make determination when proceeding with the game. The timing images and the one or more operation images may be, of course, separately displayed.

The operation position images to be displayed by the game executing portion may be displayed in an arbitrary form. By changing the luminous state of an image portion displayed in the display portion, for example, the operation position images constituted from the plurality of regions indicating the position whose luminous state has been changed as one of the operation positions may be displayed. With such arrangement, the player may recognize the operation positions constituting the plurality of regions that accept the operations at once. Luminous states of the images may be changed according to the values of evaluations. When such operation position images are displayed, the player may intuitively be informed that the stronger the luminance of an image portion is, the higher value of evaluation the region including the image portion is given.

The game executing portion may change the operation position image and may display that image as an image which indicates a particular position among the operation positions constituted from the plurality of regions to accept an operation according to the changing operation position image. When such an operation position image is set, the operation positions constituted from the plurality of regions to accept the operations indicated by the operation position images are changed. The difficulty level of the game may be therefore further increased. When the operation position image has changed into a particular image, the particular image may be used as the timing image. With such arrangement, the plurality of regions constituting the operation positions and the operation timings may be indicated by the one image. The number of the images to be checked by the player may be therefore reduced. Consequently, the burden of the player for determination may be reduced.

The game executing portion may also be so configured to allow display in the display portion evaluation result images each indicating the result of evaluation based on the results of evaluation about the operations by the player. With such arrangement, evaluation about the operations by the player may visually be confirmed by the evaluation result images. Suitability of the operations may be determined during the game. The evaluation result image based on the result of evaluation may indicate the result of evaluation by an arbitrary method. To take an example, one of the shape and color of the evaluation result image may be determined according to the degree of concordance between the operation timing defined by the sequence data and the timing detected by the timing detecting portion. Then, the other of the shape and color of the evaluation result image may be determined according to the degree of concordance between each of the operation positions constituted from the plurality of regions to accept the operations and the operated position detected by the operated position detecting portion. When such an image is displayed in the display portion, the player may visually and intuitively confirm evaluation of suitability of the timing and evaluation of suitability of the operated position.

The one or more operation portions may arbitrarily be configured. When there are a plurality of operation portions, the plurality of operation portions may be provided arranged on the display portion. In this case, each of the plurality of operation portions needs to include light permeability that allows the player to view an image displayed in the display portion, corresponding to each operation portion. With the operation portion configured as described above, the player may visually confirm the image displayed in the display portion through the operation portion. Especially when the operation portions are arranged on the display portion and then the operation position images are displayed in the display portion, the player may feel as if the operation portions indicated the operation positions.

The operation portions arranged on the display portion may be formed of a touch screen, for example.

The operation portions may be formed of push buttons. In this case, the timing detecting portion is configured to detect the timings with which the player has operated the operation portions when pressing force acts on the operation portions. The operated position detecting portion may be configured to detect the operated positions at which the pressing force is applied by using an inclination sensor capable of sensing an inclination of the operation portions or a plurality of force sensors capable of detecting the force applied to the operation portions. With such arrangement, the operated positions and the timings with which the player has operated the operation portions may be detected by a simple configuration. The operation portion may be manufactured at low cost.

In another aspect of the present invention, a control method of a game system is provided. The control method includes a display portion operable to display images; one or more operation portions to be operated by a player; a storage portion capable of storing game data at least including sequence data defining timings to be used for game, including operation timings during the game, data used to display in the display portion timing images indicating the operation timings for the one or more operation portions, and data used to display in the display portion operation position images indicating operation positions constituted from a plurality of regions to accept operations from the one or more operation portions with the operation timings; and a game executing portion. In the control method of the game system according to the present invention, the following steps are executed: displaying the timing images and the one or more operation position images in the display portion; detecting timings with which the player has operated the operation portions; detecting operated positions at which the player has operated the operation portions; evaluating an operation performed by the player based on degrees of concordance between the operation timing defined by the sequence data and the timing detected by the timing detecting step and between the operation position and the operated position; and reflecting a result of evaluation thus made in proceedings of the game.

In another aspect of the present invention, a computer program for a game system is provided. The computer program includes a display portion operable to display images; one or more operation portions to be operated by a player; a storage portion capable of storing game data at least including sequence data defining timings to be used for game, including operation timings during the game, data used to display in the display portion timing images indicating the operation timings for the one or more operation portions, and data used to display in the display portion operation position images indicating operation positions formed of a plurality of regions to accept operations from the one or more operation portions with the operation timings; and a game executing portion. The program for the game system of the present invention includes functions of: detecting timings with which the player has operated the operation portions; detecting operated positions at which the player has operated the operation portions; displaying the timing images and the one or more operation position images in the display portion; evaluating an operation performed by the player based on degrees of concordance between the operation timing defined by the sequence data and the timing detected by the timing detecting function and between the operation position and the operated position; and reflecting a result of evaluation thus made in proceedings of the game.

In one aspect of the present invention, a computer-readable non-transitory recording medium recorded with a computer program for a game system is provided. The computer program recorded in a computer-readable non-transitory recording medium includes a display portion operable to display images; one or more input portions to be operated by a player; a storage portion capable of storing game data at least including sequence data defining timings to be used for game, including operation timings during the game, data used to display in the display portion timing images indicating the operation timings for the one or more input portions, and data used to display in the display portion operation position images indicating operation positions constituted from a plurality of regions to accept operations from the one or more operation portions with the operation timings; and a game executing portion.

### BRIEF DESCRIPTION OF DRAWINGS

FIG. 1 illustrates a configuration of a game apparatus used in a music game system as a first embodiment of a game system of the present invention.

FIG. 2 is a block diagram showing an example configuration of a signal processing device in the game system of the present invention.

FIG. 3 is an explanatory diagram of details of sequence data.

FIG. 4 illustrates a sequence processing routine.

FIG. 5 illustrates an operation evaluation routine.

FIG. 6 illustrates the relationship between an operation moment and an evaluation range.

FIG. 7 is a flowchart showing an example software algorithm used when a main portion of the signal processing device of FIG. 2 is implemented, using a computer.

FIGS. 8A and 8B are explanatory diagrams of operations of an executing portion, a timing detecting portion, an operated position detecting portion, and an evaluation value giving portion in the first embodiment.

FIG. 9A illustrates an example of a plurality of regions constituting operation positions displayed by the game executing portion in the first embodiment. FIG. 9B illustrates an example of a change in an image displayed on a display screen by the game executing portion. FIG. 9C is a table showing correspondences among operation timings, the plurality of regions constituting the operation positions, and values of evaluations to be given by the evaluation value giving portion.

FIG. 10 is a table collectively showing an example of correspondences between evaluation result images and degrees of concordance between timings and correspondences between the evaluation result images and degrees of concordance between positions.

FIG. 11A illustrates another example of a plurality of regions constituting operation positions displayed by the game executing portion in the first embodiment.

FIG. 11B illustrates another example of a change in an image displayed on the display screen by the game executing portion.

FIG. 12 illustrates an example of a display portion of a portable game system as a second embodiment of the game system of the present invention.

FIG. 13 illustrates another example of the display portion of the portable game system as the second embodiment of the game system of the present invention.

FIG. 14 illustrates only a display screen and an input device extracted from a game system in a third embodiment of the present invention.

FIG. 15 is an exploded view of components taken along line XV-XV in FIG. 14.

FIG. 16 is a perspective view of each component constituting the input device of FIG. 15.

FIGS. 17A, 17B, and 17C are respectively a plan view, a side view, and a bottom view of a push-button panel.

FIG. 18 illustrates an example operation position images to be displayed in a display portion by the game executing portion, based on a plurality of regions constituting operation positions and values of evaluations given by the evaluation giving portion.

### DESCRIPTION OF EMBODIMENTS

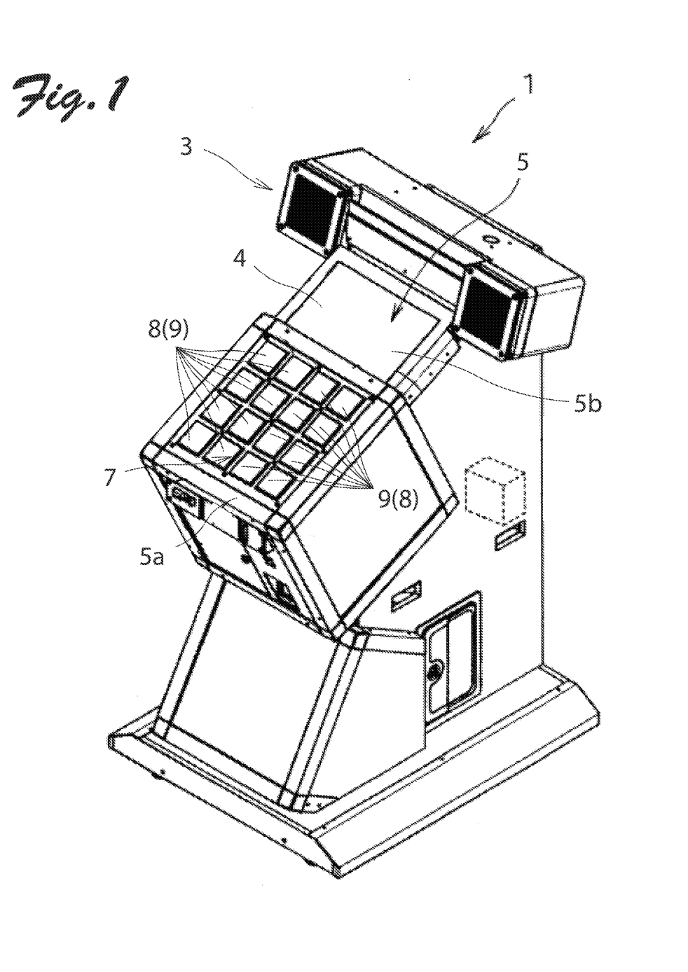

A game system of the present invention will be described below in detail, with reference to the drawings. FIG. 1 illustrates a configuration of a game apparatus 1 used in a music game system, as the game system of the present invention in a first embodiment. The game apparatus 1 in this embodiment is used for commercial space such as a game arcade. The game apparatus 1 comprises two loudspeakers 3, a display screen 5 of a display portion 4, and an input device 7 including a plurality of operation portions 8 and 9. The two loudspeakers 3 output various BGMs, an effective sound, and the like according to proceedings of a game. A general-purpose monitor constituted from a liquid crystal panel or the like may be used for the display screen 5. The display screen 5 displays various images as the game proceeds. In this embodiment, the display screen 5 is constituted from an input display screen portion 5a covered with the input device 7 and a multi-purpose display screen portion 5b not covered with the input device 7. The input device 7 is unitarily or coordinately provided with a portion of the display screen 5. An input operation to the input device 7 is performed by a player. The input device 7 in this embodiment is a touch panel type input device, and comprises 16 operation portions 8 and 9 arranged in the form of a 4×4 matrix. Eight operation portions 8 are mainly operated by the left hand of the player, and eight operation portions 9 are mainly operated by the right hand of the player. These operation portions 8 and 9 are formed of a touch screen having a function capable of detecting a touch by the player, and are each shaped in a substantial square. These operation portions 8 and 9 are arranged on the display screen in the form of the 4×4 matrix. The touch panel to be used should have light permeability by which an image displayed on the display screen can be seen through the touch panel. The touch panel may be translucent or colored. Since the other specific configurations of the touch panel type input device 7 are known, description of the other specific configurations of the touch panel type input device 7 will be omitted.

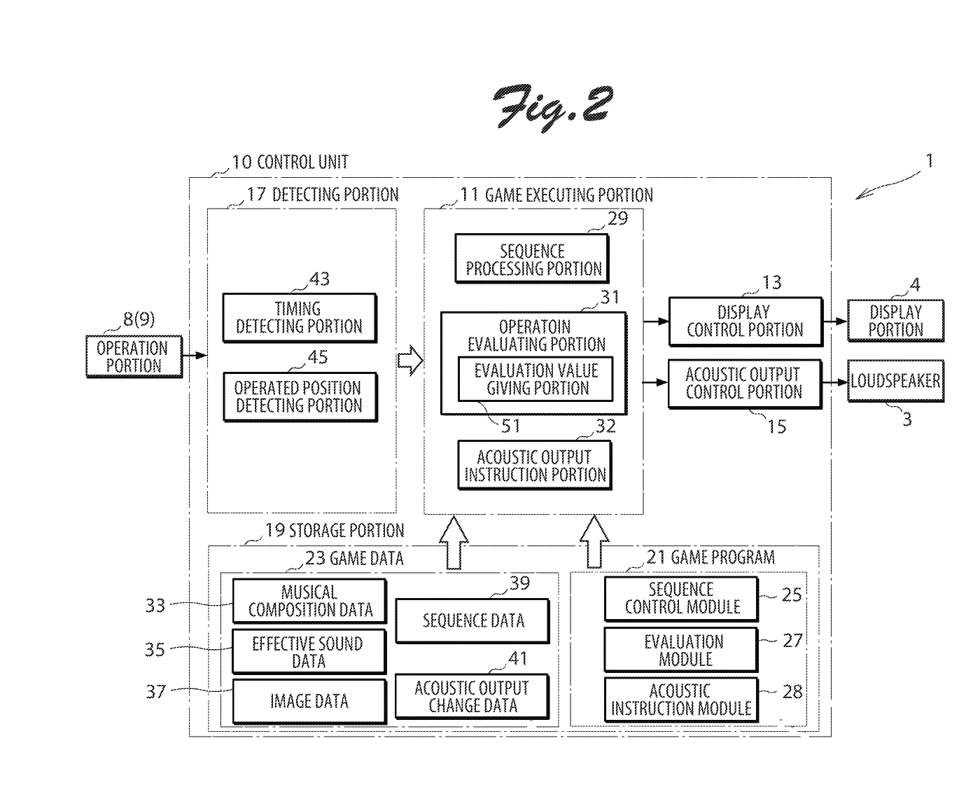

FIG. 2 is a block diagram showing an example of a configuration of a signal processing device in the game system of the present invention. As shown in FIG. 2, a control unit 10 including a computer as a main component is provided inside the game apparatus 1 in this embodiment. The control unit 10 comprises a game executing portion 11 as a main portion of the control unit 10, a display control unit 13 and an acoustic output control unit 15 each configured to operate according to an output of the game executing unit 11, and a detecting portion 17 for detecting a status of the operation units 8 and 9 operated by the player. The control unit 10 in this embodiment further comprises a storage portion 19. The game executing portion 11 is configured as a unit combining a microprocessor and various peripheral devices such as internal storage devices (e.g., a ROM and a RAM) necessary for operation of the microprocessor. The display control portion 13 renders on a frame buffer an image according to image data given from the game executing portion 11, and outputs a video signal corresponding to the rendered image to display portion 4, thereby causing a predetermined image to be displayed on the display screen 5 of the display portion 4. The acoustic output control unit 15 generates an acoustic reproduction signal corresponding to acoustic reproduction data given from the game executing portion 11 and then outputs the generated acoustic reproduction signal to the loudspeakers 3, thereby reproducing a predetermined sound (including a music sound) from the two loudspeakers 3.

The touch-panel type operation portions 8 and 9 are connected to the game executing portion 11 through the detecting portion 17. Various input devices such as a push-button switch, a cross key, or an acoustic input device (microphone) may be connected to the game executing portion 11 if necessary although they are not used in this embodiment.

The control unit 10 further includes the storage portion 19. A storage medium capable of holding storage even if no power is supplied, such as a non-volatile memory device, e.g., an EEPROM or a magnetic storage device, is used for the storage portion 19. The storage medium of the storage portion 19 may be an external storage medium which is detachable from the game apparatus 1.

A game program 21 and game data 23 are recorded in the storage portion 19. The game program 21 is a computer program necessary for executing a music game according to a predetermined procedure in the game system, and includes a sequence control module 25, an evaluation module 27, an acoustic instruction module 28, and the like. When the game system is started, the game executing portion 11 executes an operation program recorded in an internal storage device of the game executing portion 11, thereby executing various initial settings necessary for operating as the game system. Then, the game executing portion 11 loads the game program 21 from the storage portion 19 to execute the game program 21, thereby setting an environment for executing the music game according to the game program 21. In this embodiment, the sequence control module 25 of the game program 21 is executed by the game executing portion 11, thereby generating a sequence processing portion 29 in the game executing portion 11. The evaluation module 27 of the game program 21 is executed by the game executing portion 11, thereby generating an operation evaluating portion 31 in the game executing portion 11. Further, the acoustic instruction module 28 of the game program 21 is executed by the game executing portion 11, thereby generating an acoustic output instruction portion 32 in the game executing portion 11. The sequence processing portion 29, the operation evaluating portion 31, and the acoustic output instruction portion 32 are logical devices each of which is implemented by a combination of the computer hardware and the computer program. The sequence processing portion 29 instructs an operation to be performed by the player in synchronization with reproduction of music (musical composition) selected by the player, or executes a music game process such as generating an effective sound according to the operation by the player. The operation evaluating portion 31 evaluates operations on the operation portions 8 and 9 by the player, and executes a process such as game control according to results of evaluation. Various program modules necessary for executing the music game are included in the game program 21, in addition to the sequence control module 25, the evaluation module 27, and the acoustic instruction module described above. Logical devices corresponding to those modules are generated in the game executing portion 11. However, illustration of those program modules is omitted.

The game data 23 includes various data to be referred to when the music game is executed according to the game program 21. For example, the game data 23 includes musical composition data 33, effective sound data 35, image data 37, sequence data 39, and acoustic output change data 41. The musical composition data 33 is data necessary for reproducing and then outputting a musical composition to be used for the game from the loudspeakers 3. Though FIG. 2 shows one musical composition data 33, the player can actually select a musical composition to be played from among a plurality of musical compositions. A plurality of the musical composition data 33 are recorded in the game data 23, the musical composition data having respective information for identifying those plurality of musical compositions. The effective sound data 35 are data where each of a plurality of kinds of effective sounds to be output from the loudspeakers 3 in response to an operation by the player is associated with a unique code and is then recorded. The effective sound includes various types of sounds of a musical instrument and so forth. The effective sound data 35 is prepared with a predetermined number of octaves as varying tones corresponding to the respective kinds. The effective sound (sound effect) data 35 may include an effective sound, which is output according to a result of evaluation of an operation by the player, such as losing sound effect like a buzz. The image data 37 includes data for displaying in the display portion 4 game images such as timing images, operation position images, evaluation result images, background images within a game screen, and various objects and icons. The operation position images are images indicating operation positions constituted from a plurality of regions to accept operations with operation timings.

The operation positions constituted from the plurality of regions may be indicated by an arbitrary method. All of the plurality of regions may be displayed using images. In this case, the plurality of operation position images are displayed. Alternatively, a portion of the plurality of regions may be displayed using one or more images. In particular, when only one of the plurality of regions is displayed, one operation position image is displayed. In this case, the displayed one region is displayed as a so-called best region (best position).

The game data 23 further includes the sequence data 39 and the acoustic output change data 41. The sequence data 39 is data defining an operation to be instructed to the player and so on. At least one piece of sequence data 39 is provided for the musical composition data 33 on one musical composition. The acoustic output change data 41 is data used for changing rendering of a musical composition to be output from the loudspeakers 3 based on the musical composition data 33, according to a result of evaluation of an operation made by the player that has been performed by the operation evaluation portion 31 of the game executing portion 11.

The detecting portion 17 comprises a timing detecting portion 43 and an operated position detecting portion 45. The timing detecting portion 43 detects timings with which the player has operated the operation portions 8 and 9, and outputs information on the detected timings to the game executing portion 11. The operated position detecting portion 45 detects positions of the operation portions 8 and 9 at which the player has operated the operation portions 8 and 9 as operated positions, and then outputs information on the detected operated positions to the game executing portion 11.

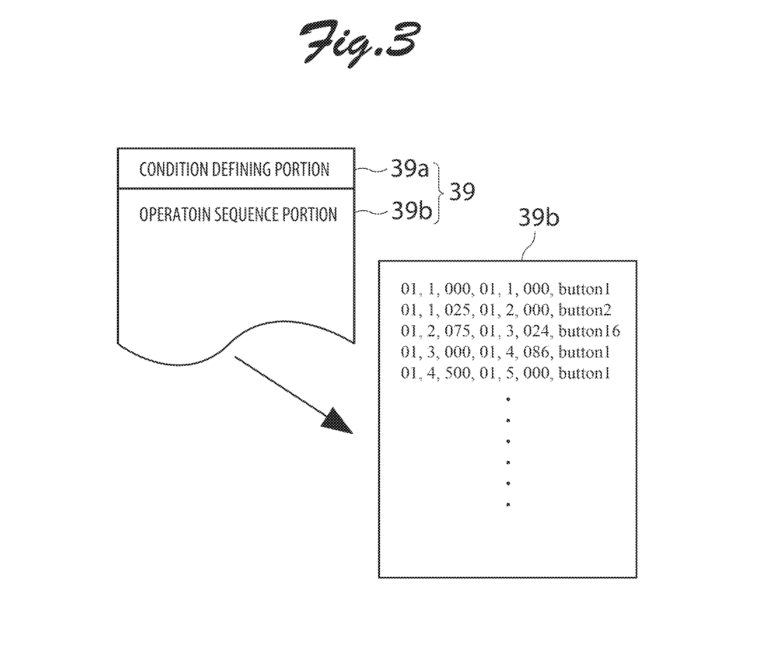

Next, details of the sequence data 39 will be described, with reference to FIG. 3. As shown in FIG. 3, the sequence data 39 includes a condition defining portion 39a and an operation sequence portion 39b. Information specifying a game executing condition or the like, which is different for each musical composition, is described in the condition defining portion 39a. This information includes information specifying a tempo of music (e.g., BPM) and sound effective to be produced when each of a plurality of the operation portions is operated if there are the plurality of the operation portions.

On the other hand, the operation sequence portion 39b is constituted from a group of a plurality of records. In each of the records, a timing (operation timing) with which an operation should be performed during a musical composition, information specifying one of the plurality of operation portions to be operated, and a time when display of an operation image (timing image and/or operation position image) is to be started are associated. In the example in FIG. 3, the time at which the display of an operation image is to be started, the operation timing, and the operation portion are described in this stated order. The time at which the display of the operation image starts is described by delimiting values showing the bar number, the number of beats, and the time during a beat of the musical composition, by commas. The time during the beat indicates a period of time elapsed from the beginning of the beat, and is expressed by the number of unit times from the beginning of the beat when a period length of the beat is equally divided into n unit periods. Assume, for example that n is set to 100. Then, when the time during the second beat in the first bar of the musical composition that has elapsed from the beginning of the beat by ¼ beat is specified, description of “01, 2, 025” is used.

When specification of a button 2 shown on the second line in FIG. 3 is taken as an example, an operation timing (01, 2, 000) for operating the operation portion corresponding to the button 2 at a starting point of time (000) of the second beat in the first bar is specified. Before this operation timing of (01, 2, 000) is specified, a display start time of (01, 1, 025) is specified. Display of (01, 2, 000, 01, 1, 025, button 2) as a whole is therefore performed. An operation image is displayed in such a manner that the operation image gradually changes in a period from the start of the display to the operation timing, based on such information. The above-mentioned sequence data may further include information on an operation end time. When the change in the display of the operation image is constant for each musical composition, the condition defining portion 39a and the program may include definitions for the case where displaying the images is started by a predetermined frame earlier than the operation timing. A similar arrangement may be made for the case where displaying the images is ended by a predetermined frame earlier than the operation timing.

While the condition defining portion 39a is provided only at the beginning of the sequence data 39 in FIG. 3, the condition defining portion 39a may be added to an arbitrary position in the operation sequence portion 39b. With that arrangement, processes such as a change in tempo and a change in effective sound assignment during the musical composition may be implemented.

A plurality of the sequence data 39 having different difficulty levels may be provided in advance for the same musical composition. Different sequence data may be prepared by culling or thinning out some of operations from the operation sequence portion 39b, for example. When the plurality of sequence data 39 having the different difficulty levels are prepared for one musical composition, information for determining the difficulty level is added to each of the sequence data 39.

The sequence processing portion 29 of the game executing portion 11 generates an image signal of a timing image indicating an operation timing for operating the operation portion based on the above-mentioned sequence data and then outputs the generated image signal of the timing image to the display control portion 13. The display control portion 13 then displays the timing image in the display portion 4. The sequence processing portion 29 generates one or more image signals of one or more of the operation position images indicating the operation positions constituted from the plurality of regions to accept operations of the one or more of the operation portions with operation timings and outputs the generated image signals of the operation position images to the display control portion 13. The display control portion 13 displays the one or more operation position images in the display portion 4.

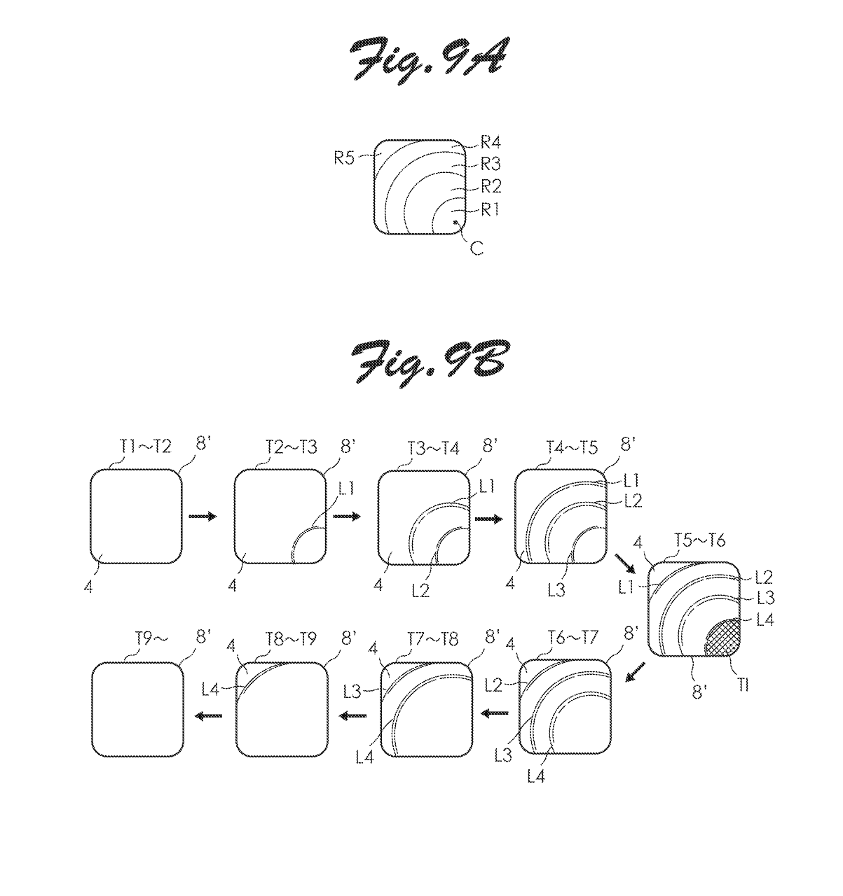

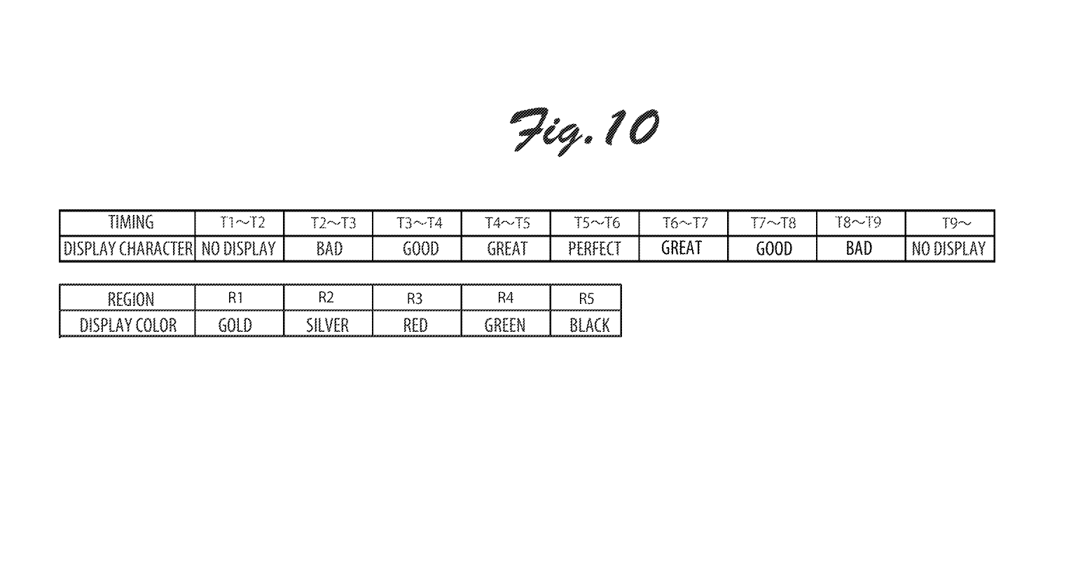

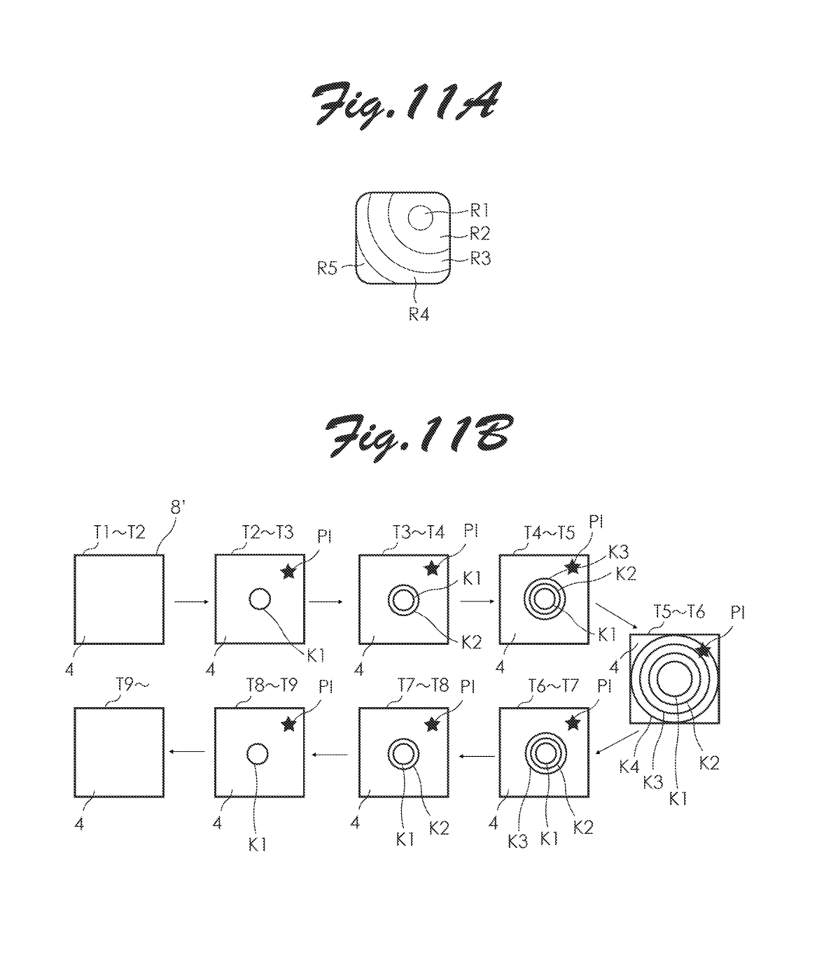

The display control portion 13 may display a timing image and an operation position image by an arbitrary method. This method will be described later in detail. Briefly, the display control portion 13 displays the timing image and the operation position image independently, as shown in FIGS. 9 and 11. The display control portion 13, however, may display the timing image and the operation position image, using one common image. When such a common image is used, an operation timing may be made to come out by blinking the operation position image with the operation timing, changing brightness or the display color of the operation position image with the operation timing, or the like, for example.

The operation evaluating portion 31 evaluates an operation by the player, based on a degree of concordance between an operation timing defined by the sequence data and a timing detected by the timing detecting portion 43 and a degree of concordance between each of the operation positions constituted from the plurality of regions and an operated position detected by the operated position detecting portion 45. In this embodiment in particular, the operation evaluating portion 31 includes an evaluation value giving portion 51 which gives a value of evaluation to each of the plurality or regions. Then, the operation evaluating portion 31 evaluates the operation by the player, in view of the value of evaluation given by the evaluation value giving portion 51.

The game executing portion 11 may further display an evaluation result image in the display portion 4, based on a result of evaluation by the operation evaluating portion 31. The acoustic output instruction portion 32 provided in the game executing portion 11 changes rendering of the musical composition to be output from the loudspeakers 3, by using the acoustic output change data 41, based on the result of evaluation by the operation evaluating portion 31. The game executing portion 11 may change the rendering of musical composition data by the acoustic output instruction portion 32, by using the acoustic output change data 41, in an arbitrary form. To take an example, a tempo of music to be reproduced may be changed. Alternatively, a musical scale, a music interval, or a pitch of the music to be reproduced may be changed. The change of the rendering may be continued for a certain period after the change, or may be continued until completion of performance of the musical composition. Further, the musical composition may be altered such that a specific effective sound based on the effective sound data 35 is output, according to the result of evaluation by the operation evaluating portion 31.

Next, a description will be directed to a process of the game executing portion 11 when the music game is executed in the game system in this embodiment. When the game executing portion 11 loads the game program 21 and then finishes the initial settings necessary for executing the music game, the game executing portion 11 waits for instructions indicating a start of the game from the player. The instructions indicating the start of the game include an operation of specifying data to be used in the game, such as selection of a musical composition to be played in the game, or selection of a difficulty level, for example. A procedure for receiving those instructions may be the same as in a known music game or the like.

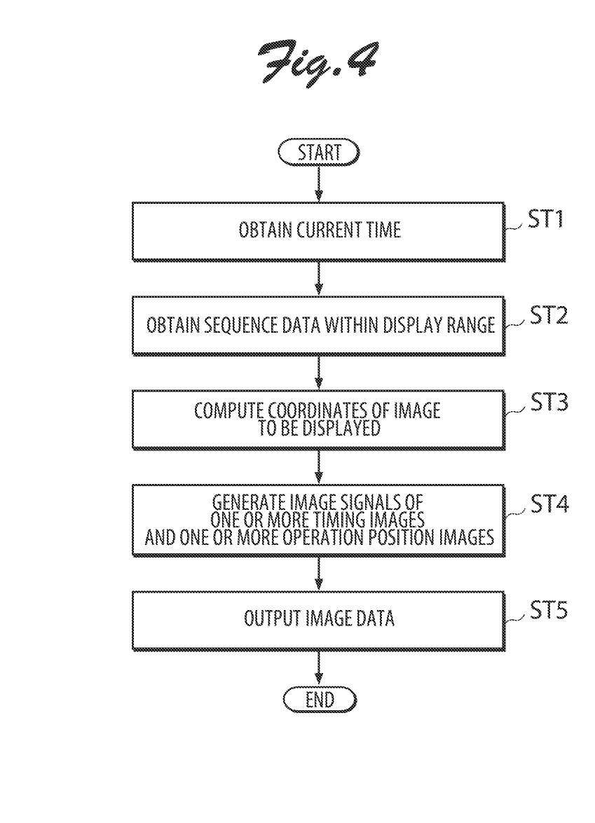

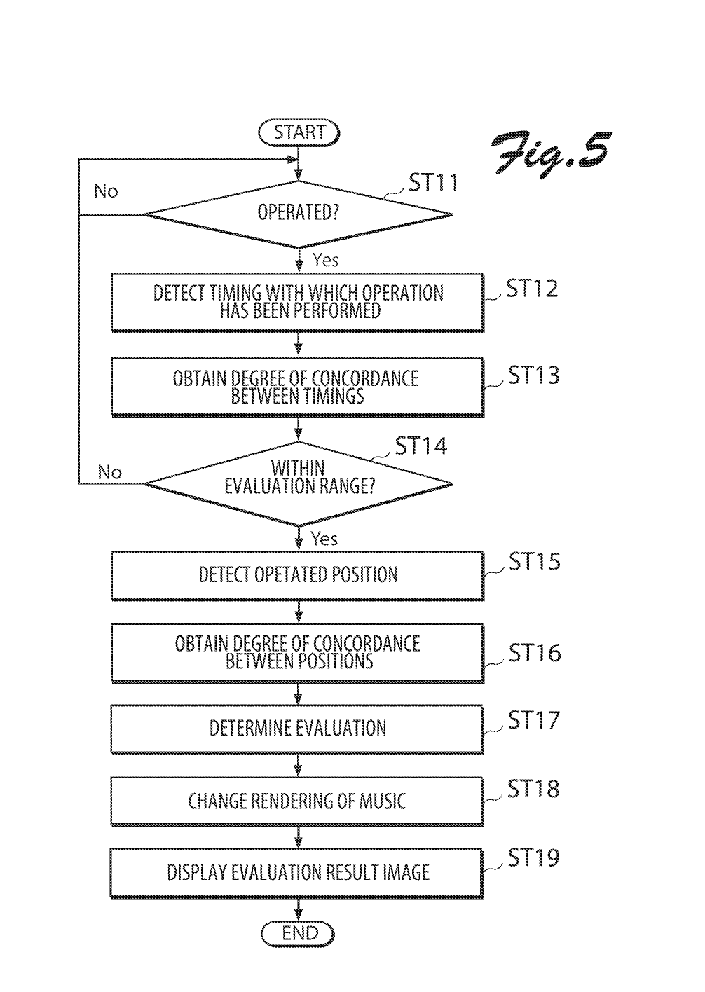

When the start of the game is instructed, the acoustic output instruction portion 32 of the game executing portion 11 reads the musical composition data 33 associated with the musical composition selected by the player to output the musical composition data 33 to the acoustic output control portion 15, thereby starting reproduction of the musical composition from the loudspeakers 3. The sequence processing portion 29 of the game executing portion 11 reads the sequence data 39 associated with the selection by the player, in synchronization with the reproduction of the musical composition. Then, the sequence processing portion 29 generates image data necessary for rendering on the display screen 5 of the display portion 4 while referring to the image data 37, and then outputs the generated image data to the display control portion 13, thereby causing timing images and one or more operation position images and various information images to be displayed in the display portion 4 in synchronization with the reproduction of the musical composition. Further, the game executing portion 11 repetitively executes each of a sequence processing routine shown in FIG. 4 and an operation evaluating routine shown in FIG. 5 in a predetermined cycle, as a process necessary for display in the display portion 4 or the like while executing the music game. The sequence processing routine in FIG. 4 is handled by the sequence processing portion 29, and the operation evaluating routine in FIG. 5 is handled by the operation evaluating portion 31, in this embodiment.

When the sequence processing routine in FIG. 4 is started, the sequence processing portion 29 of the game executing portion 11 obtains a current time during the musical composition in step ST1. For example, clocking is started from a time when the reproduction of the musical composition has been started, by using an internal clock of the game executing portion 11, and then the current time is obtained based on a value of the internal clock. In following step ST2, the sequence processing portion 29 obtains data on one or more operation timings in a time length equivalent to a display range of the display portion 4, from the sequence data 39. To take an example, the display range is set to a time range equivalent to two bars of the musical composition from the current time toward the future.

In next step ST3, the sequence processing portion 29 computes coordinates of a timing image to be displayed within the display screen 5 of the display portion 4. The computation is performed as follows, for example. That is, it is determined at which location of the display portion corresponding to the operation portion the image should be disposed, based on specification of the operation portion associated with the operation timing included in the display range or specification of one of the “button 1” to the “button 16” in the example in FIG. 3.

In next step ST4, image data necessary for rendering one or more timing images and one or more operation position images are generated, based on the coordinates of the image computed in step S3. The sequence processing portion 29 outputs the image data to the display control portion 13 in following step ST5. With that arrangement, the one or more timing images and the one or more operation position images are displayed in the display portion 4. When the process in step ST5 is finished, the sequence processing portion 29 finishes the current sequent process routine. The above mentioned processes are repetitively executed. The timing images and the operation position images are thereby displayed according to the timings described in the sequence data 39.

Next, the operation evaluating routine in FIG. 5 will be described. When the operation evaluating routine in FIG. 5 is started, the operation evaluating portion 31 determines whether any of the operation portions 8 and 9 has been operated by checking whether or not the detecting portion 17 has detected output signals of the operation portions 8 and 9. When there are no operations, the operation evaluating portion 31 finishes the current routine. When there is an operation, the procedure proceeds to step ST12. In step ST12, the detecting portion 17 detects which one of the operation portions has been operated, and the timing detecting portion 43 detects a timing with which the operation has been performed. In following step ST13, the operation timing in the sequence data 39 temporally closest to the timing with which the operation on the operation portion has been performed is identified. Then, a degree of concordance between the operation timing and the timing with which the player has operated the operation portion is obtained.

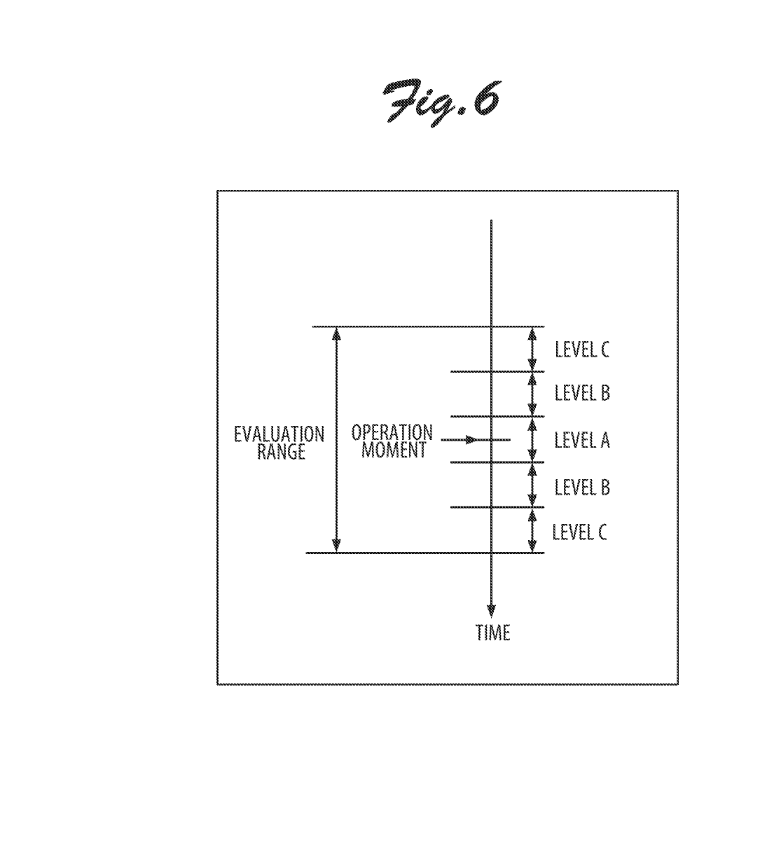

In next step ST14, the operation evaluating portion 31 determines whether or not the degree of concordance between the operation timing defined in the sequence data and the timing with which the player has operated the operation portion is within an evaluation range, thereby determining whether or not the timing with which the player has operated the operation portion is appropriate. The evaluation range may be set to a range including a predetermined time range before and after an operation moment to be compared. For example, as shown in FIG. 6, plurality of levels (levels A to C in FIG. 6) are set, centering on an operation timing, and a time range where those levels are set is treated as the evaluation range. In the example in FIG. 6, a timing indicated as an operation moment is the operation timing, and a period indicated as the level A is a best timing period. When the degree of concordance is determined to be outside the evaluation range in step ST14, the operation evaluating portion 31 assumes a standby state until the operation evaluating portion 31 detects a next output signal from the detecting portion 17. When the degree of concordance is determined to be within the evaluation range in step ST14, the procedure proceeds to step ST15.

The operated position detecting portion 45 detects a position (operated position) on one of the operation portions 8 and 9 at which the operation has been performed. In following step ST16, a degree of concordance between the detected operated position and each of the operation positions constituted from the plurality of regions to accept the operations is obtained.

Next, in step ST17, the operation evaluating portion 31 determines evaluation of the operation by the player, based on the degree of concordance between the operation timing and the timing with which the player has operated the operation portion obtained in step ST13 and the degree of concordance between the operated position and the operation position obtained in step ST16. Then, in step ST18, rendering of music to be reproduced is changed, based on the result of evaluation. In step ST19, an output to the display control portion 13 is controlled to display an evaluation result image indicating the result of evaluation on the display screen 5. When the process in step ST19 is completed, the operation evaluation portion 31 finishes the current routine.

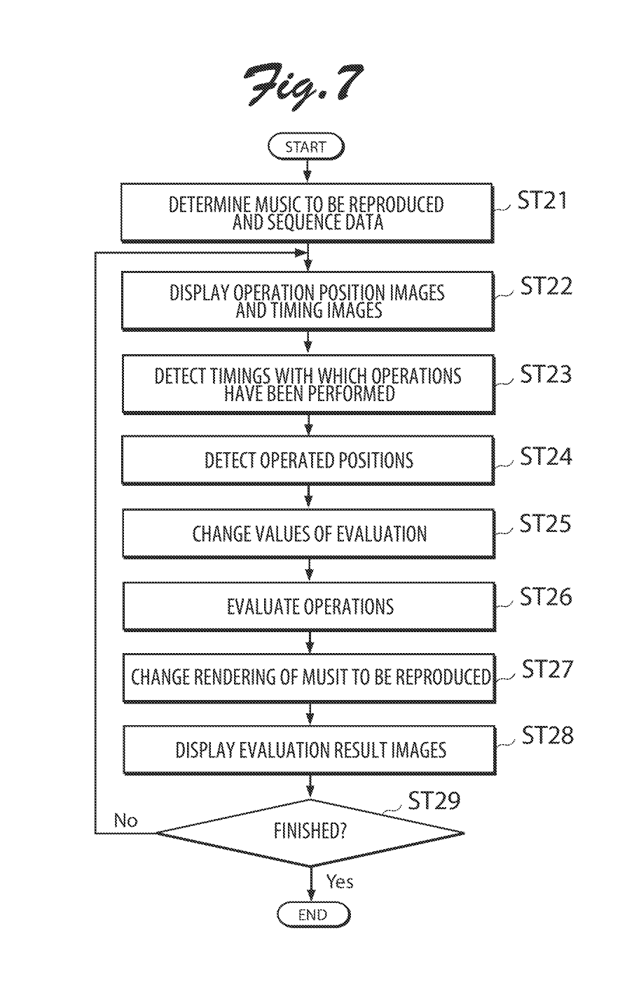

FIG. 7 is a flowchart showing an example of a software algorithm used when a main portion of the signal processing device in FIG. 2 is implemented by us ing the computer. First, in step ST21, music to be reproduced and sequence data associated with the music are determined according to settings by the player. In step ST22, the game executing portion 11 displays in the display portion the timing images indicating operation timings synchronized with the music composition to be reproduced and one or more of the operation position images indicating the operation positions constituted from a plurality of the regions to accept operations with the operation timings, based on the sequence data associated with the musical composition to be reproduced and the image data. In step ST23, the timing detecting portion 43 detects timings with which the operation portions have been operated. In step ST 24, the operated position detecting portion 45 detects positions (operated positions) at which the player has operated the operation portions 8 and 9. In step ST25, the evaluation value giving portion 51 changes values of evaluation to be given to the plurality of the regions, according to degrees of timing concordance. In step ST26, the operation evaluating portion 31 evaluates each operation based on a degree of concordance between the operation position and the operated position and the degree of concordance between the operation timing and the timing with which the operation portion has been operated, in view of the value of evaluation given by the evaluation value giving portion 51. In step ST27, rendering of the music to be reproduced by the loudspeakers 3 is changed, based on results of the evaluation of the operations evaluated by the operation evaluating portion 31. In step ST28, evaluation result images are displayed on the display screen 5 of the display portion 4, based on the results of evaluation by the operation evaluating portion 31. When reproduction of music data is not finished in step ST29, the procedure is returned to the step ST22. Then, the processes in step ST22 to step ST28 are repeated on the remaining portion of the music data.

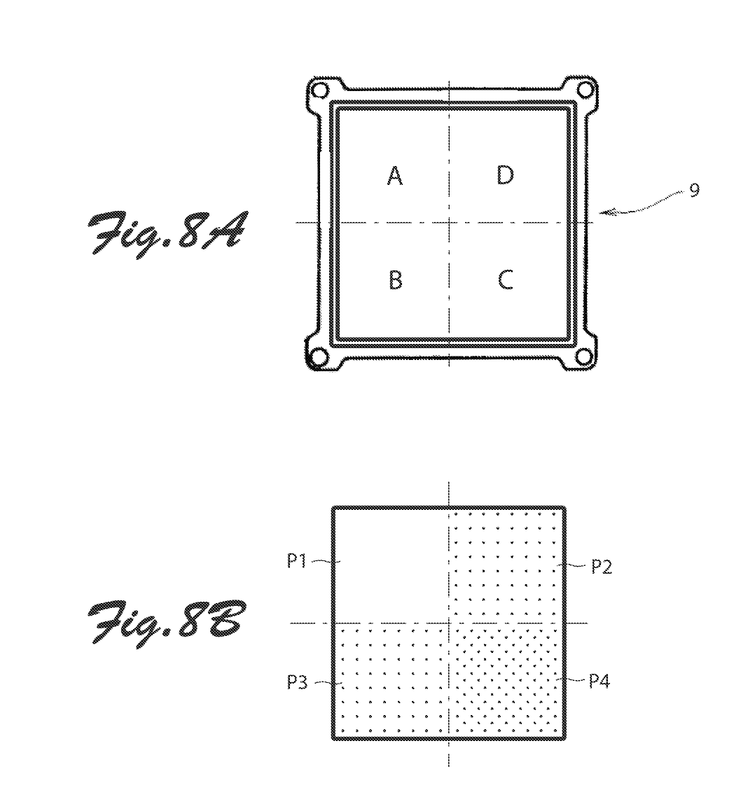

Next, an example of operations of the game executing portion 11, the timing detecting portion 43, the operated position detecting portion 45, and the evaluation value giving portion 51 in this embodiment will be described, using FIGS. 8A and 8B. The plurality of the panel-shaped operation portions 8 and 9 in this embodiment are each formed in the shape of a substantial square planar plate, as described above. Then, in order to simplify the description about FIGS. 8A and 8B, each panel is divided into four regions A, B, C, and D to obtain a plurality of regions, as shown in FIG. 8A. Then, brightness of each of the four regions A, B, C, and D is changed in order to indicate to the player each region as an operation position. Accordingly, in this example, the colored four regions A, B, C, and D constitute operation position images. The game executing portion 11 displays in the display portion a timing image in which music to be reproduced through the loudspeakers 3 and an operation timing are synchronized, for each of the four regions A, B, C, and D. Specifically, in the regions A, B, C, and D, images are displayed to allow the respective brightnesses of the regions A, B, C, and D to be increased from the previous ones with the respective timings, or to allow the respective colors of the regions A, B, C, and D to be instantaneously changed to different colors with the respective timings. When the operation timing is to be independently displayed, an image such as a mark, a character, or the like indicating arrival of the operation timing may instantaneously be displayed in one of the regions A, B, C, and D for which the operation timing has arrived, thereby displaying an operation timing image. When such an operation timing image is displayed, identification of the operation timing is facilitated.

The evaluation value giving portion 51 respectively gives values of three, two, two, and zero for the regions A, B, C, D as the plurality of regions constituting the operation positions. FIG. 8B illustrates an example operation position images to be displayed in the display portion 4 by the game executing portion based on the plurality of regions constituting the operation positions and the values of evaluation given by the evaluation giving portion 51. In the operation position images shown in FIG. 8B, a luminescence level (brightness) of an image portion indicating the position corresponding to each region is changed, according to the value of evaluation given to each region. Referring to FIG. 8B, the number of dots is inversely proportional to an intensity of brightness. Specifically, an image portion P1 corresponding to the region A is strongly illuminated, image portions P2 and P3 corresponding to the regions B and C are normally illuminated, and an image portion P4 corresponding to the region D is weakly illuminated. Since the value of evaluation of the image portion P4 is zero, the value of evaluation cannot be obtained even if this image portion P4 is operated by the player. That is, the operation is determined to be an error. When the operation position images (P1 to P3) are displayed in this manner, the player may visually recognize the relationship between the plurality of operation position images and the values of evaluation according to the luminous state of each image portion.

In this embodiment in particular, the operation portions 8 and 9 have light permeability and are each formed of the touch panel so that the player can touch the operation portions 8 and 9. Accordingly, when dimensions of each of the operation position images is set to be substantially the same as the size of each of the regions A to D, the image portions P1 to P4 completely match the plurality of regions constituting the operation positions, respectively. Thus, by checking only the luminescence level (brightness) of a position at the operation portion, the player may confirm the value of evaluation given to one of the regions to which the position belongs. The operated position detecting portion 45 detects positions (operated positions) at the operation portions operated by the player according to outputs of the operation portions 8 and 9 formed of the touch panels. The game executing portion 11 determines whether the player has operated one of the operation position images (P1 to P3) or the operation position image (P4) from which evaluation cannot be obtained on each of the operation portions 8 and 9 (that is, a degree of concordance between the operated position and each of the operation positions of the plurality of regions). The game executing portion 11 evaluates each of the operations made by the player, based on a degree of concordance between the operation timing (or the operation timing defined in the sequence data) indicated by the timing image (in this embodiment, image having brightness increased from the previous one in the regions A, B, C, D) and the timing with which one of operation portions has been operated and then detected by the timing detecting portion 43. The game executing portion 11 evaluates the operation by the player in view of the value of evaluation given by the evaluation value giving portion 51 to one of the plurality of regions A, B, C, and D having a highest degree of concordance with the operated position. In the description using FIG. 8, the panel is divided into the four regions to be set as the plurality of regions in order to simplify the description. The region division method is not limited to this method.

Next, a description will be given about an example of functions and operations of the game executing portion 11, the timing detecting portion 43, the operated position detecting portion 45, and the evaluation value giving portion 51 in this embodiment and an example of correspondences between values of evaluation to be given to a plurality of regions by the evaluation value giving portion 51 and timings detected by the timing detecting portion 43, using FIGS. 9A to 9C. In this example, the evaluation value giving portion 51 changes the value of evaluation to be given to each of the plurality of regions according to a degree of timing concordance. In this example, the game executing portion 11 sets an image center point C on a right lower portion of the operation portion 8 or 9, as shown on the page of FIG. 9A. Then, the plurality of regions on the operation portion to be touched by the player are divided into regions R1 to R5 of five stages according to the distance from the center point C. Then, the game executing portion 11 displays on the display screen 5 of the display portion 4 a plurality of substantially circular images which are concentrically generated from the center C on the right lower portion of the screen and to spread like a ripple over the display screen 5. In this example, images L1 to L4, which will be described later, become a plurality of operation position images.

In this embodiment, the game executing portion 11 displays in the display portion 4 an image of the region R1 as a timing image TI by instantaneously increasing the brightness of the image in order to indicate an operation timing. FIG. 9B stepwisely illustrates an example process in which the game executing portion 11 displays the operation position images (L1 to L4) and the timing image TI in the display portion 4 of the operation portion 8 or 9. FIG. 9C is a table showing correspondences among operation timings, the plurality of regions, and values of evaluations to be given to the plurality of regions by the evaluation value giving portion 51. In this example, the game executing portion 11 divides a period from a start of detection (T2) to an end of detection (T9) of a timing at which the player has operated the operation portion into eight stages of timing periods. Then, the game executing portion 11 evaluates an operation by the player, based on a degree of concordance between a timing of the operation in nine stages of timing periods and a display timing (operation timing) of the operation timing image TI shown by changing the brightness of the image or the like as described before. The nine stages of timing periods include a period before the start of detection (T1). When the player operates (touches) the display portion 4 in a period (T1 to T2) before the start of detection and in a period (T9) after the end of detection, values of evaluations to be given to the regions R1 to R5 by the evaluation value giving portion 51 are all zero. In a given period (T2 to T3) from the start of detection of the timing at which the player has operated the operation portion, the evaluation value giving portion 51 gives the value of evaluation of one to the region R1 located within a given distance from the center point C, and gives the value of evaluation of zero to the other regions. In this given period (T2 to T3), an arc-like or fan-like image L1 (operation position image), which is generated at the center point C is spreading like a ripple to a position corresponding to the boundary between the regions R1 and R2, is displayed in the display portion 4. In a given period (T3 to T4) after lapse of a given period from the start of detection, the evaluation value giving portion 51 gives the value of evaluation of two to the region R1, and gives the value of evaluation of one to the region R2 outside the region R1, located in a given distance from the region R1. In this given period (T3 to T4), the operation position image L1, which has spread to a position corresponding to the boundary between the regions R2 and R3, is displayed in the display portion 4. Further, another arc-like or fan-like operation position image L2, which is newly generated at the center point C and is spreading like a ripple to the position corresponding to the boundary between the regions R1 and R2, is displayed in the display portion 4. In a next given period (T4 to T5), the evaluation value giving portion 51 gives the value of evaluation of three to the region R1 and gives the value of evaluation of two to the region R2. The evaluation value giving portion 51 gives the value of evaluation of one to the region R3 outside the region R2, located in a given distance from the region R2. In this given period (T4 to T5), the operation position image L1 which has spread to a position corresponding to the boundary between the regions R3 and R4, and the operation position image L2 which has spread to the position corresponding to the boundary between the regions R2 and R3 are displayed in the display portion 4. Further, another arc-like or fan-like operation position image L3, which is newly generated at the center point C and is spreading like a ripple to the position corresponding to the boundary between the regions R1 and R2, is displayed in the display portion 4. In a next given period (T5 to T6), the evaluation value giving portion 51 gives the value of evaluation of four to the region R1, the value of evaluation of three to the region R2, and the value of evaluation of two to the region R3. The evaluation value giving portion 51 gives the value of evaluation of one to a region R4 outside the region R3, located in a predetermined distance from the region R3. The period (T5 to T6) is a so-called operation timing period (duration).

In this example, brightness of the image in the region R1 is instantaneously increased to display the image (timing image TI) different from those in the other regions in the operation timing period (T5 to T6). In this given period (T5 to T6), the operation position image L1, which has spread to a position corresponding to the boundary between the regions R4 and R5, the operation position image L2 which has spread to the position corresponding to the boundary between the regions R3 and R4, and the operation position image L3 which has spread to the position corresponding to the boundary between the regions R2 and R3 are displayed in the display portion 4. An arc-like or fan-like operation position image L4, which is newly generated at the center C and is spreading like a ripple to the position corresponding to the boundary between the regions R1 and R2, is displayed in the display portion 4. In a next given period (T6 to T7), the evaluation value giving portion 51 gives the value of evaluation which is the same as the value of evaluation given in the period (T4 to T5) to each region. In this given period (T6 to T7), the operation position image L2 which has spread to the position corresponding to the boundary between the regions R4 and R5, the operation position image L3 which has spread to the position corresponding to the boundary between the regions R3 and R4, and the operation position image L4 which has spread to the position corresponding to the boundary between the regions R2 and R3 are displayed in the display portion 4. The operation position image L1 spreads outside the display portion 4, and is not thereby displayed. Likewise, the evaluation value giving portion 51 gives the value of evaluation given in the period (T3 to T4) to each region in a next given period (T7 to T8). In this given period (T7 to T8), the operation position image L3 which has spread to the position corresponding to the boundary between the regions R4 and R5, and the operation position image L4 which has spread to the position corresponding to the boundary between the regions R3 and R4 are displayed in the display portion 4. The operation position image L2 spreads outside the display portion 4, and is not thereby displayed. In a next given period (T8 to T9), the value of evaluation given in the period (T2 to T3) is given to each region. In this given period (T8 to T9), the operation position image L4, which has spread to the position corresponding to the boundary between the regions R4 and R5, is displayed in the display portion 4. The operation position image L3 spreads outside the display portion 4, and is not thereby displayed. The value of evaluation to be given by the evaluation value giving portion 51 to the region R5 other than the regions R1 to R4 is always zero. With such arrangement, the value of evaluation that will be given to each of the plurality of regions constituting operation positions shown by the operation position images changes according to the degree of concordance between the timings. The player therefore pays more attention to a change in image indicating the operation timing. In this example, one of the operation point images located in the innermost region including the center point C matches the timing image shown by changing brightness of the image in the operation timing period. That is, indication of an optimum position (best position) to be operated and indication of a timing (best timing) with which the operation should be performed are displayed at a same location in this example. Since the images to be checked as the player proceeds with the game may be brought together, visual determination by the player is facilitated.

In this example, it is so arranged that virtual lines partitioning the regions R1 to R5 shown in FIG. 9A roughly match switching positions of the operation position images L1 to L4 shown by the respective timings in FIG. 9B. For that reason, when the value of evaluation is changed as shown in FIG. 9C, the display color of an image portion indicating each of the operation position image L1 to L4 may be changed according to the value of evaluation. To take an example, the display colors of the regions having the values of evaluations 0, 1, 2, 3, and 4 are respectively set to black, green, red, silver, and gold. With such arrangement, it may visually be recognized that the region displayed by a flashy display color, for example, has a high value of evaluation. Further, by a change in the color of the region indicating the operation position image, it may visually be recognized that, according to a degree of concordance between an operation timing shown by a change in brightness and an timing with which the player has operated the operation portion, the value of evaluation to be given to each of the plurality of regions constituting operation positions changes. In this example, configurations of the plurality of operation position images L1 to L4 change, and the plurality of regions are changed according to a change in the configurations. Accordingly, the game becomes more dynamic and more challenging. When the color of each operation position image is changed to visually and readily allow recognition of the relationship between the plurality of regions and the values of evaluation, there is an advantage that determination by the player is facilitated. Further, when brightness of an image is changed to display an operation timing, the relationship between the value of evaluation and the operation timing may visually and readily be confirmed.

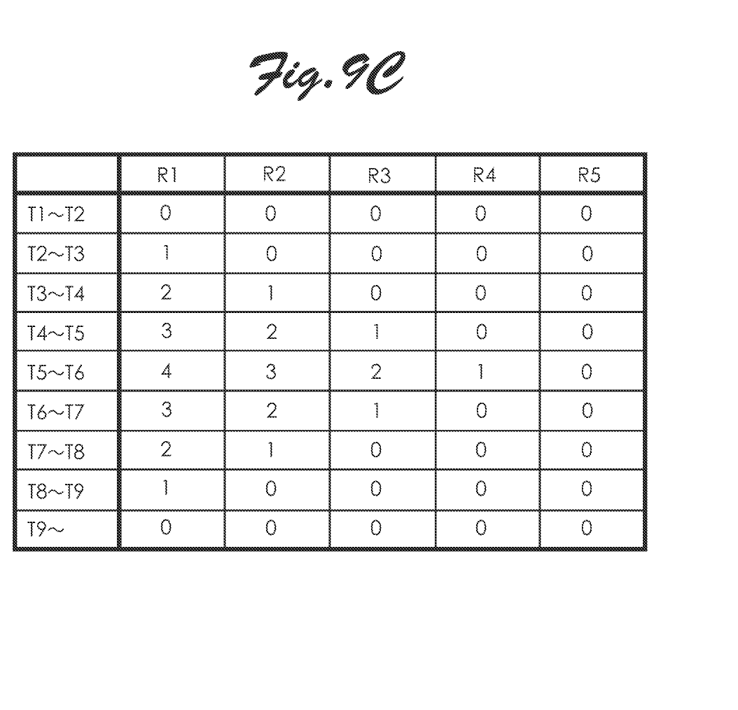

FIG. 10 is a table collectively showing an example of correspondences between evaluation result images and degrees of concordance between operation timings defined in the sequence data and timings detected by the timing detecting portion, and correspondences between evaluation result images and degrees of concordance between operated positions detected by the operated position detecting portion and operation positions. In this case, each evaluation result image about an operation is displayed in the form of a display character or the color of the display character by the game executing portion 11, based on a result of evaluation by the operation evaluating portion 31. In the example in FIG. 10, a period from a start of detection (T2) to an end of detection (T9) of a timing of the operation is divided into eight stages of periods. Then, it is detected in which one of nine stages of periods the player has operated one of the operation portions, as in the example in FIG. 9. The nine stages of periods include a period before a start of detection (T1) of the timing of the operation. The operation positions are assumed to be constituted from a plurality of regions which are divided into five regions R1 to R5. When the player has operated the region 3 in a period (T3 to T4), for example, the game executing portion 11 displays the evaluation result image where a character of “GOOD” is displayed in red. In the example in FIG. 10, the character to be displayed is determined according to a degree of concordance between an operation timing and a timing with which the player has operated the operation portion, and the display color is determined according to a degree of concordance between an operated position and each of the operation positions (constituting the plurality of regions). The display color may be, however, determined according to the degree of concordance between the operation timing and the timing with which the player has operated the operation portion, and the character may be determined according to the degree of concordance between the operated position and each of the operation positions (constituting the plurality of regions). The evaluation result image may be displayed on the input display screen portion 5a (refer to FIG. 1) for each panel, or may be displayed on the multi-purpose display screen portion 5b (refer to FIG. 1) not covered with the input device 7. Specifically, the evaluation result image may be displayed in such a manner that the color and brightness of the multi-purpose display screen portion 5b is changed according to the result of evaluation. The result of evaluation may be displayed on the multi-purpose display screen portion 5b in a large font.

FIG. 11 is a diagram showing another example of an image to be displayed in the display portion 4 of each of the operation portions 8 and 9. In this example, a center point R1 to be displayed is set in a right upper portion of the panel 9, as shown on the page of FIG. 11A. Then, a plurality of regions targeted for evaluation on each of the operation portion 8 and 9 to be operated by the player are divided into the center point R1 of the image and four stages of regions R2 to R5 according to the distance from the center point R1. Thus, there are five stages of the regions in total. That is, in this example, the center point R1 is the best position. As in the example in FIG. 9, the evaluation value giving portion 51 changes the value of evaluation to be given to each of the plurality of regions constituting operation positions according to the degree of timing concordance, in this example. Different from the example in FIG. 9, the game executing portion 11 fixedly displays only one star-shaped image PI on a right upper portion of the screen of the display portion 4 corresponding to the center point R1, as an operation position image. The portion where the star-shaped image PI is displayed indicates a position for which a highest value of evaluation is set. That is, the portion where the star-shaped image is displayed indicates a position to be touched by the player who desires to obtain a high value of evaluation. As shown in FIG. 11B, the game executing portion 11 displays timing images (K1 to K4) in the display portion 4 in order to indicate operation timings. In the timing images (K1 to K4), substantially circular images generated at the center position of the display portion 4 have fully expanded to the screen of the display portion 4, and then, contract toward the center of the display portion 4. FIG. 11B displays an example of a process where the game executing portion 11 changes the image to be displayed in the display portion 4, in a plurality of stages. In this example as well, a period from a start of detection (T2) to an end of detection (T9) of a timing with which the player has operated the operation portion is divided into eight stages of operation timing periods. Then, in this example, the operation by the player is evaluated, based on a degree of concordance between an operation timing indicated by a change such as expansion and contraction of each of the images as described before and the timing with which the player has operated the operation portion, in nine stages of operation timing periods. The nine stages of operation timing periods include a period (T1 to 12) before the start of detection and a period after the end of detection (T9) of the timing of the operation. No timing images and no operation position images are displayed in the display portion 4 in the period (T1 to T2) before the start of detection and in the period after the end of detection (T9) of the timing of the operation. The game executing portion 11 displays the star-shaped operation position image PI on the right upper portion of the screen of the display portion 4 corresponding to the center point R1 in the periods (T2 to T9) from the start of detection to the end of detection of the timing of the operation. Then, in each of periods (T2 to T3) to (T8 to T9) in FIG. 11B, the star-shaped operation position image PI is displayed in the right upper portion of the display portion 4. In this example, too, the game executing portion sets the period of (T5 to T6) to a so-called operation timing period. As shown in the period (T5 to T6), it is set that the contour of the timing image K4 positioned outermost has come into contact with (crossed) the frame of the display portion 4 in the middle of the period (T5 to T6) (which is the best timing). A moment when the timing image K4 crosses the star-shaped operation position image PI may be of course set to an operation timing.

The game executing portion 11 sequentially displays the timing images K1 to K4 in the central portion of the display portion 4, according to the sequence of the game program. Then, the game executing portion 11 generates an image signal for displaying the image formed of the timing images K1 to K4 configured as follows: the timing images K1 to K4 displayed in the central portion of the display portion 4 expand fully to the frame of the screen as the so-called operation timing period (T5 to T6) approaches, and then the timing images K1 o K4 that have expanded contract to the center portion of the display portion 4 after lapse of the operation timing period (T5 to T6). Also, in this example, it is so arranged that the evaluation value giving portion 51 changes the value of evaluation to be given to each of the plurality of regions constituting the operation positions, according to the degree of concordance between the timings. The value of evaluation to be given by the evaluation value giving portion 51 to each region may be, however, arbitrarily set. The evaluation value giving portion 51 may of course change the value of evaluation to be given to each of the plurality of regions, irrespective of the degree of concordance between the timings. In the display as in this example, the display position of the operation position image PI does not coincide with the position which allows the player to visually confirm that the timing images K1 to K4 indicate the operation timings. Accordingly, it is necessary for the player to simultaneously recognize indication of the operation timing (position where the timing image K4 comes into contact with the frame of the display portion 4) and indication of the operation position (* mark (star mark)) displayed at the position different from the position of indication of the operation timing. The difficulty level of the game therefore increases. Consequently, interest of the player in the game may be enhanced.

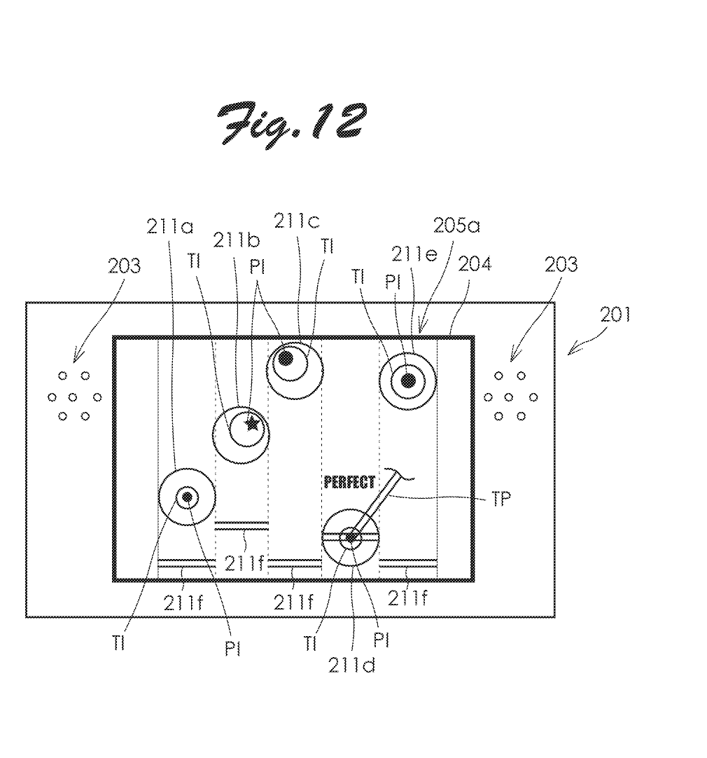

FIG. 12 shows a plan view of a portable game apparatus as a second embodiment of a game system in the present invention. This game apparatus 201 includes two loudspeakers 203 and a display screen 205a including a function of a touch panel as a display portion 204. As the portable game apparatus including the touch panel, a portable game apparatus already on the market may be used. Thus, specific explanation about a configuration of the game apparatus 201 will be omitted. Various images for indication including timing images and operation position images are displayed on the display screen 205a as a game proceeds. A player operates an operation portion by touching the touch panel with a touch pen TP, according to a displayed image for indication.

A note image 211 including five circular note marks 211a to 211e and five timing bars 211f associated with the respective note marks is displayed on the display screen 205a in FIG. 12. In this embodiment, a game executing portion 11 displays an operation position image PI inside each of the note marks 211a to 211e as an operation position image, thereby indicating a best position. In the example in FIG. 12, * (star marks) marks and • marks (bullet or circle marks) in the circles of the note marks and so forth are each the operation position image PI for which a value of evaluation is set to be high. Each note mark is generated from an upper portion of the page of the drawing, and moves to a lower portion of the page of the drawing. Then, the game executing portion 11 displays a timing image so that a timing with which the operation image PI in each note mark overlaps with a corresponding one of the timing bars 211f is the best operation timing. Specifically, timing images TI (indicated by ∘ marks in note marks) are each displayed to be overlapped with the operation image PI (indicated by the * mark or • mark, for example). Each of the note marks 211a to 211e moves toward the timing bar 211f. An evaluation of the timing operation starts when the timing image TI has overlapped with the timing bar 211f. A timing with which the operation position image PI (indicated by the * mark or • mark) has overlapped with the timing bar 211f is evaluated as the best operation timing.

FIG. 12 shows a moment where the player is touching the position of the • mark (operation position image PI) with the touch pen TP when the • mark (operation position image PI) in the note mark 211d overlaps with the timing bar 211f. In the state in FIG. 12, the operation of touching the operation position image PI with the touch pen TP is perfect in terms of the timing and the position. Accordingly, the character of “PERFECT” is displayed as an evaluation result image indicating a result of evaluation based on degrees of concordance between the timings and between the positions. When the degree of concordance between the timings is bad, the character of “bad” is displayed as an image indicating evaluation of the timing and the position. When the degrees of concordance between the timings and between the positions are in an allowable range, the character of “good” is displayed. In this example, the operation position image PI indicating the operation position and the timing image TI indicating the timing with which the player should operate the operation portion overlap with each other. Thus, when the player operates one note mark, the player should note just one position. Determination by the player is thereby facilitated.

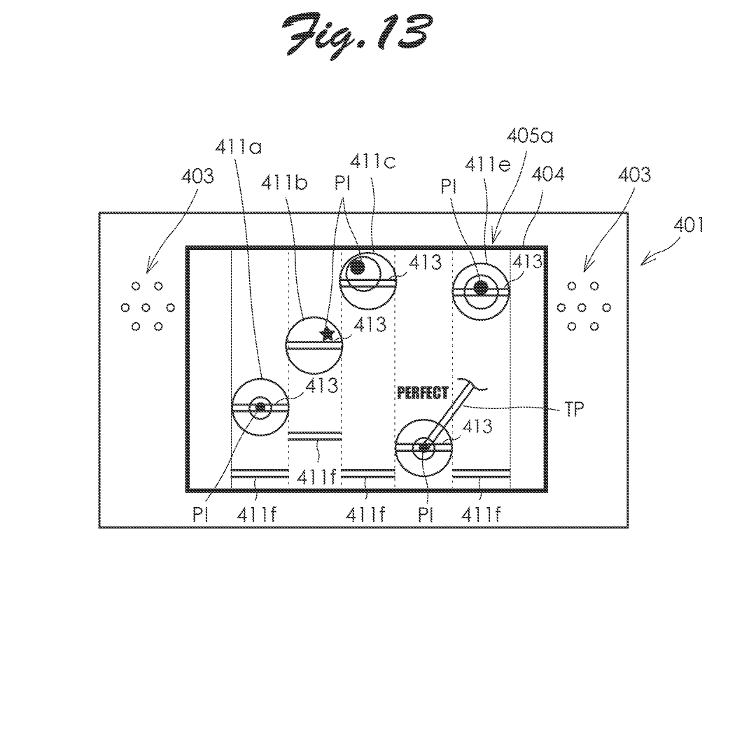

FIG. 13 is a diagram showing a variation example of the second embodiment of the game system in the present invention. Referring to FIG. 13, description of components which are the same as those in the embodiment shown in FIG. 12 will be omitted by giving to the same components reference numerals obtained by adding 200 to the reference numerals in FIG. 12. In this example, too, a note image 411 including five circular note marks 411a to 411e and five timing bars 411f associated with the respective note marks are displayed on a display screen 405a. In this example, * and • marks in the circles of the note marks indicate operation position images PI for which values of evaluations are set to be high. A region between an operation position image PI and a ◯ mark (circle mark) outside the operation position image PI is an operation position image for which a value of evaluation is set to be low. In this example, a timing image 413 is displayed in each note mark. The timing image 413 passes through the center of the note mark. The timing image has the same shape of a bar image as a timing bar 411f, and displays a best timing. The game executing portion 11 displays the timing image so that a timing with which this timing image 413 overlaps with the timing bar 411f is the best operation timing.

FIG. 13 shows a moment where the player is touching the position of the • mark (operation position image) with the touch pen TP when the timing image 413 overlaps with the timing bar 411f. In the example in FIG. 13, the operation of touching the operation position image (indicated by the • mark) is perfect in terms of the timing and the position. Accordingly, the character of “PERFECT” is displayed as an evaluation result image showing evaluation of the timing. When degrees of concordance between the timings and between the positions are bad, the character of “bad” is displayed as an image indicating evaluation of the timing. When the degrees of concordance between the timings and between the positions are in an allowable range, the character of “good” is displayed. In this example, display positions of the operation position images (indicated by the • and * marks) do not match the timing images 413 indicating operation timings. Thus, it is necessary to separately check concordance between positions and concordance between timings. The difficulty level of the game thereby increases.

In the second embodiment as well, an evaluation value giving portion 51 may be configured to change the value of evaluation to be given to each of a plurality of regions according to a degree of concordance between an operation timing and a timing detected by a timing detecting portion, as in the first embodiment. Alternatively, the evaluation value giving portion 51 may be configured to change the value of evaluation, irrespective of the degree of concordance between the operation timing and the timing detected by the timing detecting portion.

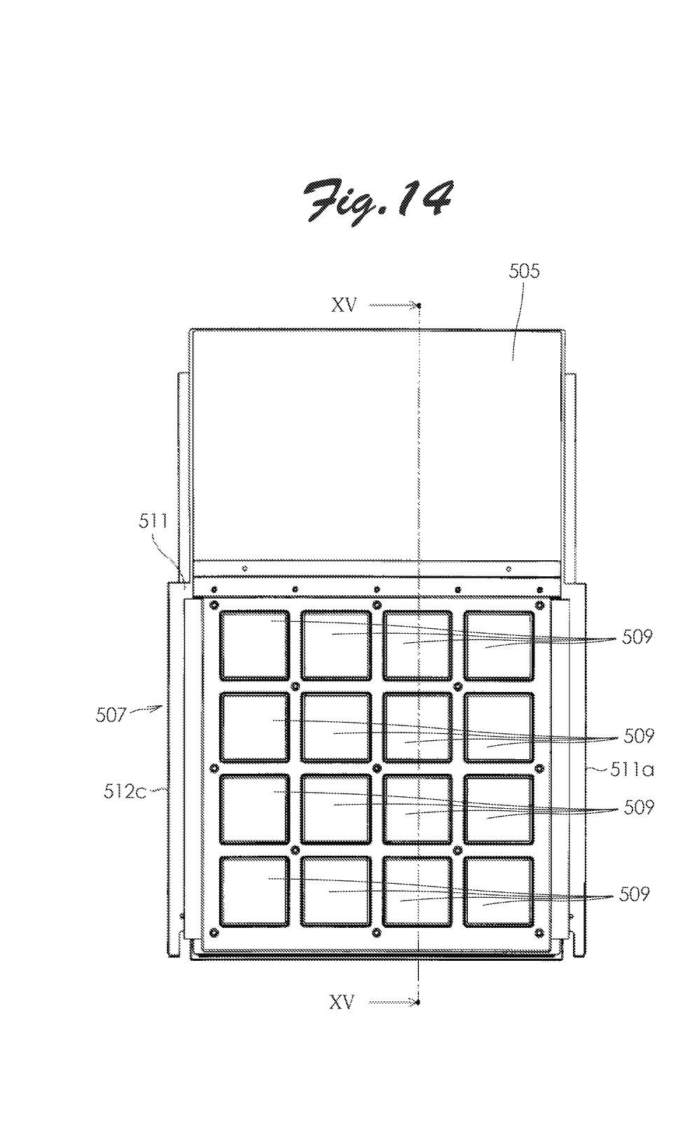

FIG. 14 illustrates only a display screen 505 and an input device 507 extracted from a game apparatus 501 of a game system in a third embodiment of the present invention.

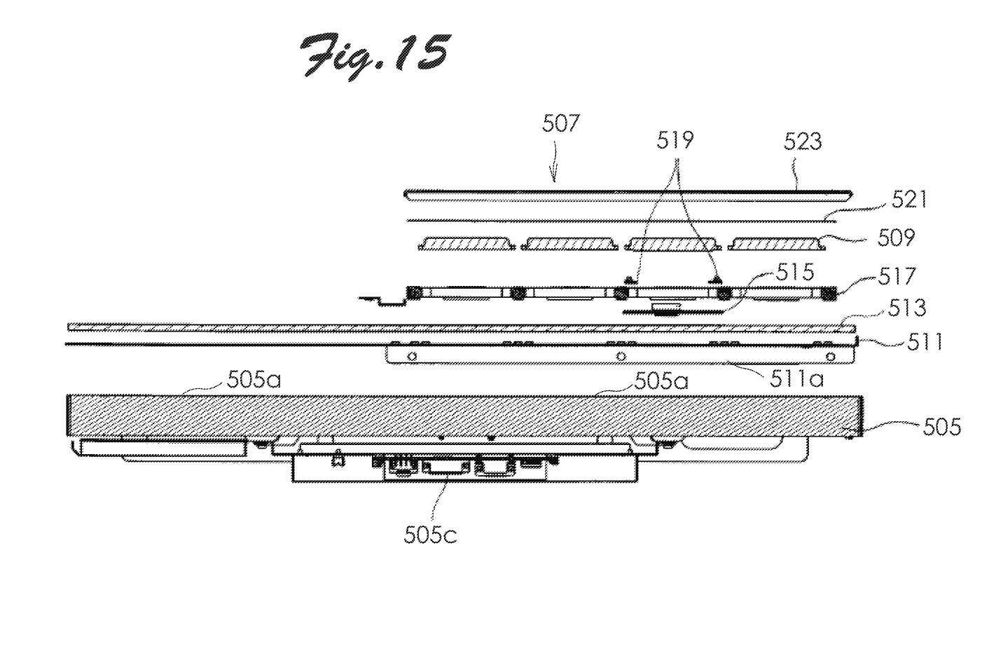

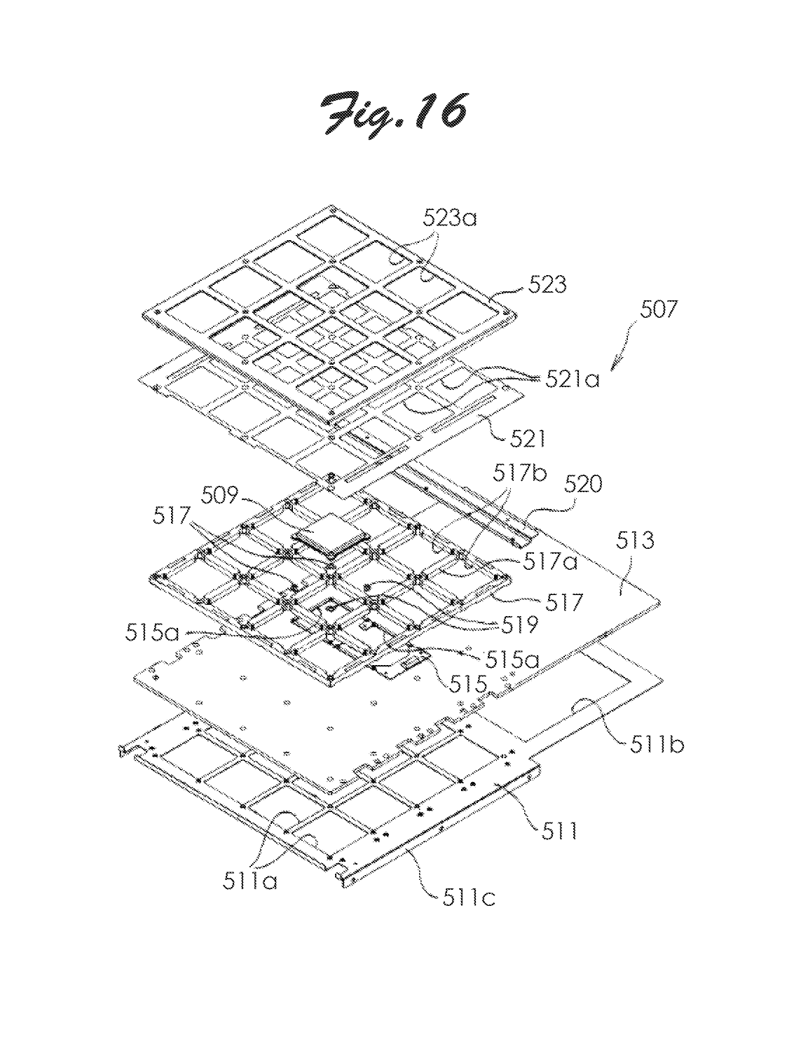

FIG. 15 is an exploded view of components taken along a line XV-XV in FIG. 14. FIG. 16 is a perspective view of each component constituting the input device 507 in FIG. 15. Since the game apparatus 501 in this embodiment has the same appearance as the game apparatus 1 shown in FIG. 1, illustration of the appearance of the game apparatus 501 will be omitted. A signal processing device disposed inside the game apparatus 501 in this embodiment has the same configuration as the signal processing device disposed inside the game system shown in FIG. 1. An operation portion 508 in this embodiment includes 16 push-button panels 509 of a push-button type that function as operation portions to be touched by a player. The 16 push-button panels 509 are each shaped in a substantially square and made of a transparent resin. The push button panels are arranged on the display screen in a 4×4 matrix form. The push-button panel 509 should have light permeability by which an image displayed on the display screen 505 may be seen, and may be translucent or colored.

A terminal portion 505c for connecting a video cable or the like for transmitting an image signal of an image to be displayed on the display screen 505 is provided on the back surface of the display screen 505. The input device 507 is constituted from a base 511, a lattice base 513, panel substrates 515, a lattice panel 517, rubber contacts 519, a button cover 521, a lattice cover 523, and the push-button panels 509. The base 511 is formed by processing a metal plate, and functions as a basal plate for joining the whole of the input device 507 to the body of the game apparatus 501. The base 511 has a size that completely covers the display screen 505. The Base 511 is provided with 16 punched portions (511a) for the 16 push-button panels arranged in the form of a 4×4 matrix in portions corresponding to an input display screen portion 505a of the display screen 5 in order for a player to visually recognize an image displayed on the display screen 505 through the input device 507. One punched portion (not shown) for the screen is provided in a portion of the base 511 corresponding to a multi-purpose display screen portion 505b. Folded portions 511c for fixing the input device 507 including the base 511 to the body of the game apparatus 501 are formed on both sides of the base 511.

The lattice base 513 is overlaid on the base 511. The lattice base 513 is a base board shaped into a flat plate for ensuring rigidity of the input device 507, and is wholly formed of a transparent plastic. The lattice base 513 has a size capable of wholly covering the base 511 except the folded portions 511c. The panel substrates 515 are overlaid on the lattice base 513. The panel substrate 515 is a printed circuit board for electrically connecting the rubber contacts 519. In this embodiment, each panel substrate 515 is disposed on the lattice base 513 such that the panel substrate 515 is shared by a mutually adjacent two of the push-button panels 509. Accordingly, the number of the panel substrates 515 is eight in total. The panel substrates 515 also have punched portions (515a) in positions corresponding to the push-butt on panels 509. FIG. 15 shows only one panel substrate 515.

The lattice panel 517 is a partitioning member for partitioning the input display screen portion 505a into a plurality of regions corresponding to the push-button panels 509, and is formed by combining frames formed of an opaque plastic in the forms of a lattice. Sixteen void portions (517a) are provided between the respective frames of the lattice panel 517, as in the punched portions of the base 511 for the pushed button panels.

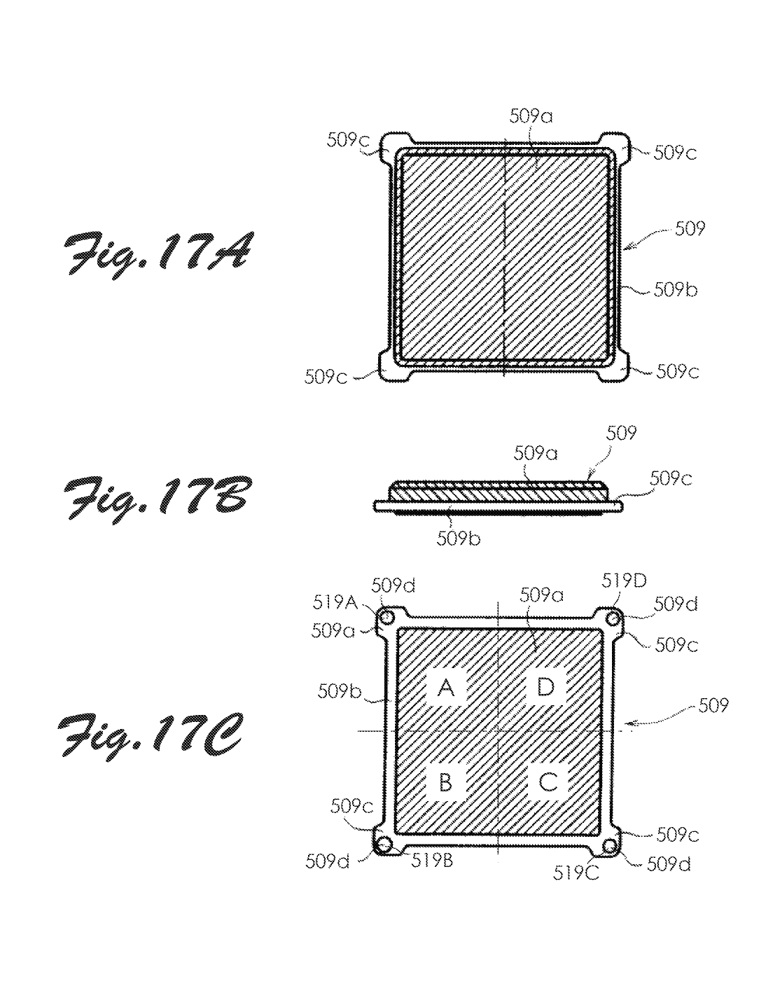

The push-button panels 509 are components provided as the operation portions to be operated by the player and are respectively arranged for the void portions 517a of the lattice panel 517. As shown in FIGS. 17A to 17C, each push-button panel 509 includes a plate-like panel body 509a in the shape of a substantially square flat plate (hatched portion) and a flange 509b disposed on the lower surface of the panel body 509a to rim the periphery of the panel body 509a. Enlarged portions 509c protruding in diagonally outward directions of the push-button panel 509 are provided at four corners of the flange 509b as portions of the flange 509b. Circular concave portions 509d are respectively formed in the back surfaces (lower surfaces) of the enlarged portions 509c. Referring to FIG. 17C, four rubber contacts 519A to 519D are respectively provided at the four concave portions 509d. The push-button panel 509 is a formed of the transparent plastic, and mirror-like finishing is applied to front, back, and side surfaces of the panel body 509a. With that arrangement, the panel body 509a has a high transparency with which an image on the display screen 505 below the panel body 509a may visually be recognized sharply. Blasting process is applied to the flange 509b including the enlarged portions 509c. With this arrangement, transparency of the flange 509b is reduced to a state of a fogged glass. The reason why the transparency of the flange 509b is reduced is that the base 511, the panel substrate 515 and the rubber contacts 519 disposed under the push-button panel 509 are not seen through the panel body 509a.

Returning to FIGS. 15 and 16, the rubber contacts 519 are provided between the panel substrate 515 and the respective circular concave portions 509d at the four corners of the push-button panel 509. The rubber contact 519 is a component including rubber as an elastic body and an electrode. The rubber serves as means for supporting the push-button panel 509 such that the push-button panel 509 is movable upwardly and downwardly at the four corners of the push-button panel 509. The electrode is incorporated in the elastic body so as to be operable to detect a depressing operation of the push-button panel 509. When the rubber contact 519 is compressively deformed by the depressing operation of the push-button panel 509, the electrode inside the rubber contact 519 is electrically conducted. When the compressive deformation is released, electrical conduction of the electrode is released. A rubber contact already on the market may be used for the rubber contact 519 of this type. The rubber contacts 519 function as a plurality of force sensors for detecting force applied to the push-button panel 509. Electrical conduction and release of the electrical conduction of the electrode inside the rubber contact 519 is transmitted to the signal processing device disposed in the game apparatus 501 through the panel substrate 515, as information on a position (operated position) at which the operation portion has been operated and information on a timing with which the operation portion has been operated. In this embodiment, a moment when the player has contacted the push-button panel 509 and then pressing force has acted on the operation portion is detected as the timing with which the operation portion has been operated. The operated position is detected by outputs of the rubber contacts 519A to 519D provided at each push-button panel 509. The button cover 521 is provided for protecting an inside of the input device 507 from entry of dust or the like. Void portions (521a) for exposing the panel body 509a of the push-button panel 509 are formed in the button cover 521. The button cover 521 is formed of an opaque material such as a resin. The lattice cover 523 is provided as a decorative panel for partitioning the push-button panels 509. Void portions 523 (523a) for exposing the panel bodies 509a of the push-button panels 509 are formed in the lattice cover 523. The lattice cover 523 is an opaque component, and is formed of a metal, for example.

Next, a description will be directed to example operations of the game executing portion 11, the operation evaluating portion 31, and the evaluation value giving portion 51 in this embodiment, referring to FIGS. 17B and 17C. In this embodiment, each of the plurality of push-button panels (operation portions) 9 is shaped in a substantially square flat plate, as described above. The push-button panel (operation portion) 9 includes the rubber contacts 519A to 519D at the four corners thereof. Then, in this embodiment, the game executing portion 11 divides each push-button panel into four regions A, B, C, and D, as shown in FIG. 17C to beset to a plurality of regions constituting operation positions. The game executing portion 11 displays in the display portion 4 a timing image for each of the four regions A, B, C, and D. In the timing image, music to be reproduced by the loudspeakers 3 is synchronized with an operation timing. Specifically, respective timing images of the regions A, B, C, and D are simultaneously displayed. Specifically, image display for instantaneously increasing brightness of a corresponding one of image portions P1 to P4 so far used with the operation timing set for each of the regions A, B, C, and D or instantaneously changing the color of a corresponding one of the regions so far used with the operation timing. When the operation timing is independently displayed, image display of the operation timing may be performed by instantaneously displaying an image such as a mark or a character indicating arrival of the operation timing in the region for which the operation timing has arrived. When such a timing image is displayed, identification of the operation timing is facilitated.

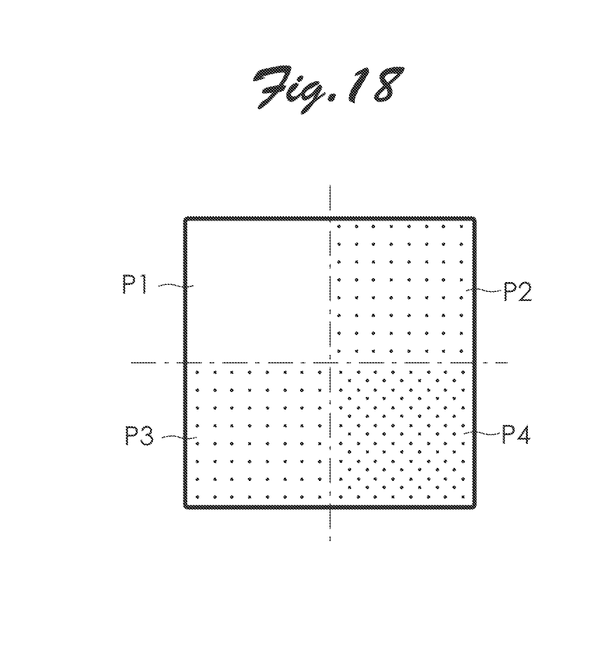

The evaluation value giving portion 51 shown in FIG. 2 respectively gives values of three, two, two, and zero for plurality of regions A, B, C, and D. FIG. 18 illustrates example of the operation position images to be displayed in the display portion 4 by the game executing portion 11 based on the plurality of regions constituting the operation position and the values of evaluation given by the evaluation giving portion 51. In the operation position images shown in FIG. 18, a luminescence level (brightness) of the image portion indicating the position corresponding to each region is changed, according to the value of evaluation given to each region. Referring to FIG. 8, the number of dots is inversely proportional to an intensity of the brightness. Specifically, the image portion P1 corresponding to the region A is strongly illuminated, the image portions P2 and P3 corresponding to the regions B and C are normally illuminated, and the image portion P4 corresponding to the region D is weakly illuminated. Since the value of evaluation of the image portion P4 is zero, no value of evaluation is obtained even if this image portion P4 is operated (touched) by the player with an operation timing. That is, the operation is determined to be an error. When the operation position images (P1 to P3) are displayed in this manner, the player may visually recognize the relationship between the plurality of operation position images and the values of evaluation according to the luminous state of each image portion.

In this embodiment in particular, the plurality of push-button panels 509 each have light permeability and are configured to be capable of being touched by the player. Accordingly, when the size of each operation position image is set to be substantially the same as the size of each push-button panel 509, the image portions P1 to P4 respectively match the plurality of regions constituting the operation positions. Then, the player may confirm the value of evaluation given to the region of the operation portion according to the luminescence level (brightness) of a position on the operation portion. The operated position detecting portion 45 detects a position (operated position) on the operation portion of the push-button panel 509 operated by the player, according to outputs of the four rubber contacts 519A to 519D provided at the four corners of the push-button panel 509. The four rubber contacts 519A to 519D are respectively provided corresponding to the regions A, B, C, and D constituting the operation positions. Specifically, when the rubber contacts 519A to 519D are compressively deformed by a depressing operation of the push-button panel 509, the electrode inside each rubber contact is electrically conducted. Then, an electrical conduction signal is transmitted to the signal processing device disposed in the game apparatus 1 through the panel substrate 515. The electrical conduction signal is a signal whose voltage value changes according to an amount of deformation caused by the compressive deformation. As a result, the region including one of the rubber contacts 519A to 519D that has output a largest voltage signal is detected as an operated position operated by the player. The plurality of rubber contacts, in this case, function like the plurality of force sensors. The game executing portion 11 detects degrees of concordance between the operated position detected from outputs of the rubber contact for the regions A, B, C, and D and the respective operation positions constituted from the plurality of regions. The game executing portion 11 also detects a degree of concordance between the operation timing defined in sequence data as described before and the timing with which the operation has been performed. The operation evaluating portion 31 detects one of the regions A, B, C, and D having a highest degree of concordance, and evaluates the input according to the degree of concordance between the timings and the degree of concordance between the positions, in view of the value of evaluation the evaluation value giving portion 51 has given to the detected region.

### INDUSTRIAL APPLICABILITY

According to the present invention, an operation by a player is evaluated according to a degree of concordance between timings and a degree of concordance between positions. Thus, the player is made aware of not only matching the timings of the operation but also matching the positions of the operation. Interest of the player in the game may be therefore prevented from being lost.

### REFERENCE SIGNS LIST

1 game apparatus
3 loudspeaker
4 display portion
5 display screen
5a input display screen portion
5b multi-purpose display screen portion
7 input device
10 control unit
11 game executing portion
13 display control portion
15 acoustic output control portion
17 detecting portion
19 storage portion
21 game program
23 game data
25 sequence control module
27 evaluation module
28 acoustic instruction module
29 sequence processing portion
31 operation evaluating portion
32 acoustic output instruction portion
33 musical composition data
35 effective sound data
37 image data
39 sequence data
39a condition defining portion
39b operation sequence portion
41 acoustic output change data
43 timing detecting portion
45 operated position detecting portion
51 evaluation value giving portion

1. A game system comprising:
a display portion operable to display game images;
one or more operation portions to be operated by a player;
a storage portion capable of storing game data at least including sequence data defining operation timings during game, data used to display in the display portion timing images indicating operation timings for the one or more operation portions, and data used to display in the display portion operation position images indicating operation positions constituted from a plurality of regions to accept operations from the one or more operation portions with the operation timings;
a timing detecting portion operable to detect timings with which the player has operated the one or more operation portions;
an operated position detecting portion operable to detect operated positions at which the player has operated the operation portions; and
a game executing portion operable to execute the game, displaying the game images in the display portion based on one or more operation signals and the game data, the game executing portion configured to:
display the timing images and the one or more operation position images in the display portion according to the sequence data;
evaluate an operation performed by the player based on degrees of concordance between the operation timing defined by the sequence data and the timing detected by the timing detecting portion and between the operation position and the operated position; and
reflect a result of evaluation thus made in proceedings of the game, wherein:
a separate value of evaluation is given to each of the plurality of regions;
the game executing portion displays the operation position images such that the relationship between the plurality of regions and the values of evaluation may visually be confirmed;
the game executing portion displays the relationship by changing the colors of the operation positions according to the values of evaluation;
the game executing portion integrally displays the timing images and the operation position images;
the game executing portion changes the operation position image and indicates the operation timing by using a particular image when the operation position image has changed into the particular image;
the game executing portion displays in the display portion evaluation result images each indicating the result of evaluation based on the results of evaluation;
the game executing portion determines one of the shape and color of the evaluation result image according to the degree of concordance between the operation timing defined by the sequence data and the timing detected by the timing detecting portion, and determines the other of the shape and color of the evaluation result image according to the degree of concordance between the operation position and the operated position; and
the plurality of operation portions are formed of a touch screen disposed on the display portion.

2. A game system comprising:
a display portion operable to display game images;
one or more operation portions to be operated by a player;
a storage portion capable of storing game data at least including sequence data defining operation timings during game, data used to display in the display portion timing images indicating operation timings for the one or more operation portions, and data used to display in the display portion operation position images indicating operation positions constituted from a plurality of regions to accept operations from the one or more operation portions with the operation timings;
a timing detecting portion operable to detect timings with which the player has operated the one or more operation portions;
an operated position detecting portion operable to detect operated positions at which the player has operated the operation portions; and
a game executing portion operable to execute the game, displaying the game images in the display portion based on one or more operation signals and the game data, the game executing portion configured to:
display the timing images and the one or more operation position images in the display portion according to the sequence data;
evaluate an operation performed by the player based on degrees of concordance between the operation timing defined by the sequence data and the timing detected by the timing detecting portion and between the operation position and the operated position; and
reflect a result of evaluation thus made in proceedings of the game.

3. The game system according to claim 2, wherein
a separate value of evaluation is given to each of the plurality of regions.

4. The game system according to claim 3, wherein
the game executing portion displays the operation position images such that the relationship between the plurality of regions and the values of evaluation may visually be confirmed.

5. The game system according to claim 4, wherein
the game executing portion displays the relationship by changing the colors of the operation positions according to the values of evaluation.

6. The game system according to claim 2, wherein
the game executing portion integrally displays the timing images and the operation position images.

7. The game system according to claim 6, wherein
the game executing portion changes the operation position image and indicates the operation timing by using a particular image when the operation position image has changed into the particular image.

8. The game system according to claim 2, wherein
the game executing portion displays in the display portion evaluation result images each indicating the result of evaluation based on the results of evaluation.

9. The game system according to claim 8, wherein
the game executing portion determines one of the shape and color of the evaluation result image according to the degree of concordance between the operation timing defined by the sequence data and the timing detected by the timing detecting portion, and determines the other of the shape and color of the evaluation result image according to the degree of concordance between the operation position and the operated position.

10. The game system according to claim 2, wherein
the plurality of operation portions are formed of a touch screen disposed on the display portion.

11. The game system according to claim 2, wherein:
the operation portions are formed of push buttons;
the timing detecting portion is configured to detect the operation timings when pressing force acts on the operation portions; and
the operated position detecting portion is configured to detect the operated positions at which the pressing force is applied, based on an output from an inclination sensor capable of sensing an inclination of the operation portions or a plurality of force sensors capable of detecting the force applied to the operation portions.

12. A control method of a game system which includes a display portion operable to display images; one or more operation portions to be operated by a player; a storage portion capable of storing game data at least including sequence data defining operation timings during game, data used to display in the display portion timing images indicating the operation timings for the one or more operation portions, and data used to display in the display portion operation position images indicating operation positions constituted from a plurality of regions to accept operations from the one or more operation portions with the operation timings; and a game executing portion, the method comprising the steps of:
displaying the timing images and the one or more operation position images in the display portion;
detecting timings with which the player has operated the operation portions;
detecting operated positions at which the player has operated the operation portions;
evaluating an operation performed by the player based on degrees of concordance between the operation timing defined by the sequence data and the timing detected by the timing detecting step and between the operation position and the operated position; and
reflecting a result of evaluation thus made in proceedings of the game.

13. A computer program for a game system which includes a display portion operable to display images; one or more operation portions to be operated by a player; a storage portion capable of storing game data at least including sequence data defining operation timings during game, data used to display in the display portion timing images indicating the operation timings for the one or more operation portions, and data used to display in the display portion operation position images indicating operation positions constituted from a plurality of regions to accept operations from the one or more operation portions with the operation timings; and a game executing portion, the program installed in a computer to cause the computer to perform the functions of:
detecting timings with which the player has operated the operation portions;
detecting operated positions at which the player has operated the operation portions;
displaying the timing images and the one or more operation position images in the display portion;
evaluating an operation performed by the player based on degrees of concordance between the operation timing defined by the sequence data and the timing detected by the timing detecting function and between the operation position and the operated position; and
reflecting a result of evaluation thus made in proceedings of the game.

14. A computer-readable non-transitory recording medium recorded with a computer program for a game system which includes a display portion operable to display images; one or more operation portions to be operated by a player; a storage portion capable of storing game data at least including sequence data defining operation timings during game, data used to display in the display portion timing images indicating the operation timings for the one or more operation portions, and data used to display in the display portion operation position images indicating operation positions constituted from a plurality of regions to accept operations from the one or more operation portions with the operation timings; and a game executing portion, the program installed in a computer to cause the computer to perform the functions of:
detecting timings with which the player has operated the operation portions;
detecting operated positions at which the player has operated the operation portions;
displaying the timing images and the one or more operation position images in the display portion;
evaluating an operation performed by the player based on degrees of concordance between the operation timing defined by the sequence data and the timing detected by the timing detecting function and between the operation position and the operated position; and
reflecting a result of evaluation thus made in proceedings of the game.
